(19) United States
(12) Patent Application Publication
(10) Pub. No.: US 2026/0189770 A1
(43) Pub. Date: Jul. 2, 2026

(54) GENERATIVE AI-BASED MULTI-AGENT SYSTEM FOR VIDEO MANAGEMENT SYSTEMS AND APPLICATIONS

(71) Applicant: NVIDIA Corporation, Santa Clara, CA (US)

(72) Inventors: Roopa Prabhu, San Jose, CA (US); Rohit Ramesh Vaswani, San Jose, CA (US); Nalin Dadhich, San Jose, CA (US); Bruno Alvisio, San Bruno, CA (US); Joshua Roorda, Santa Clara, CA (US)

(21) Appl. No.: 19/005,470

(22) Filed: Dec. 30, 2024

(51) Int. Cl. H04N 21/84; G06F 9/54; G06F 16/242; H04N 21/845

(52) U.S. Cl. CPC H04N 21/84; G06F 9/54; G06F 16/2445; H04N 21/8456

(57) ABSTRACT

In various examples, a generative AI-based agentic architecture may be used to improve the performance of user interfaces associated with video management systems. The agentic architecture may include a primary agent that collaborates with specialized agents to respond to user queries (e.g., natural language queries) received via a user interface associated with a particular video management system. For instance, to generate a response to a query, the primary agent may decompose the query into a plurality of instructions (e.g., sub-queries) to be sent to a relevant subset of the specialized agents. The specialized agents may use one or more language models to understand the instructions and call one or more specialized tools to obtain information, perform operations, or otherwise respond in accordance with the instructions. In some instances, the specialized agents may include video storage agents, video analytics agents, vision language model agents, and/or any other agents.

### BACKGROUND

Operations centers (e.g., command centers, control centers, etc.) have become integral to the monitoring, control, and management of various environments. Typically, operations centers use unified user interfaces to consolidate multiple data sources, applications, monitoring tools, and/or other modules into a single display or dashboard, often referred to as a “single pane of glass.” This design may enable experienced users to view and interact with various information streams in one place, rather than having to switch between different screens or systems in order to monitor various activities and/or systems.

However, this approach often falls short in terms of user experience and operational efficiency. For instance, one primary limitation of traditional operations center systems is their reliance on static interfaces. Since users may be required to interact with a fixed layout of modules, each representing different data streams or system statuses, this rigidity may hinder real-time decision-making, as users may be required to manually sift through and interpret information from disparate sources. Additionally, these systems often lack intelligent navigation capabilities, which can significantly increase the cognitive load on users because the users may be required to have a deep understanding of the entire operations center system to effectively navigate its interface. This necessity for extensive knowledge can lead to inefficiencies, increased response times, and heightened potential for human error.

### SUMMARY

Embodiments of the present disclosure relate to generative artificial intelligence (AI)-based multi-agent systems and applications. Systems and methods are disclosed that may be used to improve the performance, functionality, and intuitiveness of user interfaces associated with operations centers and/or similar systems by using a generative AI-based agentic architecture to query, process, and visualize these systems. In some examples, the agentic architecture may include a primary agent that collaborates with one or more specialized agents to respond to user queries (e.g., natural language queries) received via a user interface. For instance, to generate a response to a query, the primary agent may use one or more first language models to process the query and determine a plan for responding to the query. In some instances, this may include decomposing the query into a plurality of instructions or sub-queries, as well as identifying a relevant subset of the specialized agents to send one or more of the instructions or sub-queries to. The specialized agents may use one or more second language models to understand the instructions or sub-queries and call one or more tools to obtain or determine information in accordance with the instructions. For instance, the specialized agents may use the second language model(s) to convert the instructions or sub-queries into application programming interface (API) calls, structured query language (SQL) statements, etc., and use these modalities to obtain the information. The specialized agents may forward the information or a description thereof to the primary agent, and the primary agent may use this data to generate a response to the original query.

In contrast to conventional systems, the systems of the present disclosure, in some embodiments, may enable easier and/or more intuitive navigation of complex systems, such as command center user interfaces and/or similar systems. For instance, instead of a user being required to have a certain level of knowledge or experience with a complex system, the systems of the present disclosure allow users to interact with complex systems using natural language queries (e.g., text, speech, etc.). In this way, users having even a basic level of knowledge of the user interface or system may be able to easily control and/or monitor the system via the generative AI-based user interface. Additionally, in contrast to conventional systems, the systems of the present disclosure may, in some embodiments, be able to more efficiently navigate system modules, obtain and analyze data, predict trends, resolve anomalies, deploy or control machines, and/or perform any other operations by leveraging the generative AI-based agentic architectures disclosed herein. For instance, by inputting a simple natural language query, a user may leverage the systems of the present disclosure to perform one or more operations in a matter of seconds that would previously have taken an experienced user—or a team of experienced users—significantly more time to perform (e.g., minutes, hours, etc.).

### BRIEF DESCRIPTION OF THE DRAWINGS

The present systems and methods for generative AI-based multi-agent systems and applications are described in detail below with reference to the attached drawing figures, wherein:

FIG. 1 is a data flow diagram illustrating an example of a process for using an AI-based agentic architecture to generate a response to a query, in accordance with some embodiments of the present disclosure;

FIG. 2 is a block diagram illustrating example detail associated with an agent, in accordance with some embodiments of the present disclosure;

FIG. 3 illustrates an example of a multi-agent architecture, in accordance with some embodiments of the present disclosure;

FIG. 4 illustrates an example of a multi-agent architecture associated with a video management system, in accordance with some embodiments of the present disclosure;

FIGS. 5A-5C are data flow diagrams illustrating examples of a primary agent communicating with a plurality of specialized agents to respond to a query, in accordance with some embodiments of the present disclosure;

FIG. 6 is a flow diagram illustrating an example of a method that may be implemented by a multi-agent architecture to respond to a query, in accordance with some embodiments of the present disclosure;

FIG. 7 is a flow diagram illustrating an example of a method for responding to a query using an AI-based agentic architecture, in accordance with some embodiments of the present disclosure;

FIG. 8 is a flow diagram illustrating an example of a method that may be implemented by a multi-agent architecture for a video management system, in accordance with some embodiments of the present disclosure;

FIG. 9 is a flow diagram illustrating an example of a method for responding to a query using an AI-based agent architecture associated with a video management system, in accordance with some embodiments of the present disclosure;

FIG. 10 is a flow diagram illustrating an example of a method that may be performed by an AI-based agent to respond to instructions received from a primary agent, in accordance with some embodiments of the present disclosure;

FIG. 11A is a block diagram of an example generative language model system suitable for use in implementing at least some embodiments of the present disclosure;

FIG. 11B is a block diagram of an example generative language model that includes a transformer encoder-decoder suitable for use in implementing at least some embodiments of the present disclosure;

FIG. 11C is a block diagram of an example generative language model that includes a decoder-only transformer architecture suitable for use in implementing at least some embodiments of the present disclosure;

FIG. 12 is a block diagram of an example computing device suitable for use in implementing at least some embodiments of the present disclosure; and

FIG. 13 is a block diagram of an example data center suitable for use in implementing at least some embodiments of the present disclosure.

### DETAILED DESCRIPTION

Systems and methods are disclosed related to generative AI-based multi-agent systems and applications. For instance, a system(s) may include a primary agent (also referred to herein as a “planning agent”) that collaborates with one or more specialized agents to respond to user queries (e.g., natural language queries) received via input to a user interface. To generate responses to queries, the primary agent may use one or more first language models to process a query and determine a plan for responding to the query. In some instances, this may include the primary agent decomposing the query into a plurality of instructions (also referred to herein as “sub-queries”) and identifying at least a subset of relevant, specialized agents to execute the instructions. The specialized agents may, in some examples, use one or more second language models to understand the instructions and call one or more tools to obtain or determine information in accordance with the instructions. The specialized agents may then forward the information—or a description of the information generated using the second language model(s)—to the primary agent (and/or other specialized agents), and the primary agent may use data from specialized agents to generate a response (e.g., a multimodal response) to the original query.

As described herein, in some examples, the primary agent and/or the first language model(s) of the primary agent may be augmented and/or trained (updated) using one or more configuration files. The configuration file(s) may include information and/or specifications associated with the multi-agent architecture. For example, the configuration file(s) may indicate, among other things, the uses, capabilities, tools, etc., of each one of the specialized agents, sample queries for each of the specialized agents, network endpoints for the specialized agents, and/or other information. As an example, for a video storage agent, the configuration file may indicate that the video storage agent may be used to obtain segments of videos stored in a database, that a sample query may include “obtain the feed of camera 1 from 10:00-10:05 PM on Oct. 10, 2024,” and a valid URL, IP address, etc., for the video storage agent. In some examples, the configuration file(s) may be applied as an augmentation and/or training input to the first language model(s) of the primary agent. For instance, the first language model(s) may be augmented and/or trained (updated), using the configuration file(s), to determine relevant agents to invoke for responding to certain queries, to generate instructions or sub-queries in a format or schema that is understood by the agents, to reason through complex queries, etc.

In some examples, the primary agent may receive or otherwise obtain input data representing a query (e.g., a natural language query) or other request for information. The query or request may be sent by a computing device that is executing an instance of the multi-agent system associated with an operations center, a command center, a video management system, and/or any other centralized managing and monitoring system. In some instances, the input data may be multimodal. For instance, the input data may include text data representing the query, audio data representing speech containing the query, image data or a stream of image data (e.g., a video) representing an image or video associated with the query, etc. For instance, in the context of image data or the stream of image data, a user may use sign language gestures to sign the query.

Additionally, or alternatively, the query may include additional or supplemental data associated with the query, which may be represented using image data, audio data, video data, and/or any other type of data. As an example, a user may upload an image and submit a query (e.g., by typing in the query, uttering the query, etc.) associated with the image, such as “which camera captured this image?”, “when was this image taken?”, or “can you obtain the live feed of the camera that took this image?” In such examples, the input data may include image data (corresponding to the additional data and/or the query), as well as text data, audio data, or any other data.

In some examples, the primary agent may analyze the query or request represented in the input data and determine a plan for obtaining the requested information or otherwise responding to the query. For instance, the primary agent may use the first language model(s)—which may include one or more LLMs, one or more SLMs, one or more VLMs, one or more multimodal language models, etc.—and/or any other machine learning models, to process the input data and determine the plan. In some instances, the plan may include a subset of the specialized agents that the primary agent should communicate with in order to obtain any necessary information for responding to the query. As an example, if the query states “what is happening right now at camera 1?”, the primary agent may use the first language model(s) to understand the query and decompose the query into one or more tasks that need to be completed in order for the primary agent to respond. In this example, the tasks may include at least obtaining the video feed for the camera from a first agent (e.g., a video storage toolkit (VST) agent) and analyzing the video feed to determine what is happening or otherwise depicted in the video using a second agent (e.g., a VLM agent).

As described herein, the way in which the primary agent may query the specialized agents to obtain necessary information for responding to queries may vary from one implementation to another implementation and/or vary based on the substance of the query. For example, in some instances the primary agent may simply forward the input data representing the original query (e.g., the query received from the user) to all of, or a subset of, the specialized agents. In such an example, the specialized agents may then determine the relevant information they may be able to provide, and provide that information to the primary agent for generating the response. Additionally, after receiving one or more first responses from the specialized agents, the primary agent may analyze the first response(s) and/or information therein to determine if it can respond to the user. If the information is incomplete, the primary agent may send additional queries to the specialized agents (which may include some of the information already obtained from some of the agents, additional context, additional requests or instructions, etc.) to obtain the additional information. Once the primary agent determines it has the information it needs, it may then use the information to respond to the query.

Additionally, or alternatively, in some instances the primary agent may, based on the plan, generate one or more instructions or sub-queries related to the original query, and send these instruction(s)/sub-query(ies) to the specialized agents and/or a select subset (e.g., one or more) of the specialized agents. For instance, based at least on processing the input data and/or the plan using the first language model(s), the primary agent may generate first text data representing the instruction(s) for obtaining the information from the select number of specialized agents. In such instances, the primary agent may send a first subset of the instruction(s) to a first subset of the specialized agents, a second subset of the instruction(s) a second subset of the specialized agents, and so forth. In some examples, the plan may indicate that some information may be needed from a first specialized agent before one of the instructions can be submitted to a second specialized agent. Take, for example, the scenario described above in which the query states “what is happening right now at camera 1?” In this example, the primary agent may need to first obtain the video feed from the VST agent by sending the VST agent first instruction(s), and then forward the video feed and/or second instructions to the VLM agent for analysis. Additionally, or alternatively, the primary agent may cause the VST agent to forward the video feed directly to the VLM agent (e.g., using the instructions).

As described herein, in various examples, the specialized agents may receive the input data representing the query, or the first text data representing the instruction(s) or the sub-query(s), or any other data from the primary agent and process the data using the second language model(s). The specialized agents may use the second language model(s) to process the input data or first text data in order to understand the query, the instruction(s), and/or the sub-query(ies) (e.g., understand the intent or the specific request). For instance, the specialized agents may analyze this data using the second language model(s) to determine one or more tools to use to obtain the information requested by the primary agent. Additionally, using the second language model(s), the specialized agents may, in some instances, convert the input data or first text data into second text data representing one or more API calls, one or more SQL statements or queries, or any other computer-executable instructions for obtaining the information. The specialized agents may execute the API call(s) and/or send the SQL statements to a relational databased for execution to determine or otherwise obtain the information. Upon obtaining the information, in some instances the specialized agents may need to summarize or otherwise reformat the information by converting the information into a natural language sentence(s), phrase(s), etc., so the primary agent may understand the information. As such, the specialized agents may use the second language model(s) to generate third text data corresponding to the information, and then send the third text data back to the primary agent as the response to the query, the instruction(s), and/or the sub-query(ies).

Additionally, in some examples, the specialized agents may, depending on the query, instruction(s), or sub-query(ies), perform requested operations/tasks in addition to, or in the alternative of, obtaining information for the primary agent to respond to a query. For instance, the primary agent may request the specialized agents to store something in a database, to delete items from the database, to reorganize items in the database, to reformat stored data, update documentation, or perform any other output-type operations. Additionally, in some examples, the system(s) may include, among other agents, control agents that may control various machines, equipment, resources, access, etc. As an example, based on receiving a query from a user, the primary agent may invoke a control agent to control one or more operations of one or more machines (e.g., autonomous or semi-autonomous machines). This may include, in some instances, causing one or more autonomous machines or vehicles to use a different path, begin operation, cease operation, navigate to a specific location, or any other operations. Additionally, or alternatively, the control agents may be used to lock or unlock doors of buildings (e.g. to restrict or permit access), turn lighting off or on, operate HVAC systems, operate security cameras (e.g., turn off or on, adjust field of view (e.g., zoom, camera pose, orientation, etc.)), operate sound systems, operate appliances, activate or deactivate alarms, operate manufacturing equipment, or any other operations. In some instances, these operations may be performed in conjunction with user queries and/or may be performed autonomously and the user interface updated retroactively to inform users of the operations. For instance, assume in a warehouse setting that an aisle or path is blocked such that autonomous machines may not traverse the aisle/path. In such scenarios, the system(s) may detect the obstruction, update the autonomous machines to use a different path or avoid the obstructed aisle/path, and then send a notification for output by the user interface to notify of the obstruction and the actions taken in response. In other words, the system(s) may detect an event, invoke the multi-agent architecture responsive to detecting the event, respond to the event (e.g., deploy machines, lock doors, shut down equipment, record the event, etc.), and then provide this information to the primary agent to generate output associated with the event/responses for display on the user interface.

In some examples, the specialized agents may be unavailable and the primary agent may dynamically change the plan and/or use other agents in order to respond to the user submitted query. For instance, if one specialized agent is unresponsive or the specialized agent's tools are unavailable (e.g., database is inaccessible, etc.), the specialized agent may send a response to the primary agent to inform the primary agent of the condition. Upon receiving the response, the primary agent may determine to send the query or instruction(s) to a backup agent that has the same or similar tools. Alternatively, or additionally, if no such backup agent exists, the primary agent may determine whether it is possible to adequately respond to the query without the information. If it is not possible to respond, the primary agent may send such a response to the user interface indicating that the query cannot be completed. In some examples, rather than the primary agent sending the query or instruction(s) to a backup agent that has the same or similar tools, the specialized agent may forward the query or instruction(s) directly to the backup agent by leveraging its own capabilities.

As described herein, in various instances the tools, functions, roles, and behaviors of the specialized agents may vary from one system to another. For instance, a multi-agent architecture for a video management system may include a database or SQL agent for generating SQL statements or queries for interacting with a relational database, a VST agent for storing and retrieving videos or segments of videos, an analytics agent for communicating with an analytics engine (e.g., NVIDIA's Metropolis or any other analytics engine), a VLM agent including one or more VLMs or multimodal language models (MMLMs) for analyzing, interpreting, and explaining the content of the videos or images, etc. In additional or alternative embodiments, the multi-agent architecture may include documentation agents, control agents, and/or any other types of agents.

In some examples, the primary agent may receive the necessary information for responding to the original query from the specialized agent(s). The primary agent may use the first language model(s) to process the information available to it to generate the response. For instance, the primary agent may process, using the first language model(s), the input data representing the original query, the first text data representing the instruction(s) or sub-query(ies) sent to the specialized agents, the third text data representing the information/responses from the specialized agents, and/or other data to generate the response to the query. In some examples, the primary agent may use the first language model(s) to generate a textual portion of a multimodal response. For instance, the multimodal response may include audio data, image data, text data, and/or any other kind of data, and the first language model(s) may generate the text data of the multimodal response. As an example of a multimodal response, the response may include text representing a natural language sentence(s), an image (e.g., an image of a camera of a video management system), a segment of a video, audio recorded in conjunction with the video, a link to the image or the video, etc.

The primary agent may send, to the computing device executing the instance of the user interface, output data corresponding to the response to the query. In some examples, the output data may cause the computing device to cause presentation of the response (e.g., the multimodal response). For instance, the computing device may cause presentation of the response by displaying, on the user interface, the text data representing the natural language response, image data, videos, or any other data that may be visualized. Additionally, in some examples, the computing device may cause presentation of the response audibly using one or more speakers connected to the computing device. In some examples, the system(s) may include text to speech and/or automatic speech recognition (ASR) engines for converting text data to audio data and/or converting audio data representing speech to text data. In some examples, the response data may further include one or more selectable options, input fields, and/or other forms of receiving additional user input related to the response to the query. For instance, if an initial query recites “is camera 1 active?”, the response to the query may include text data that recites “yes, camera 1is active, would you like to see the video feed?” along with a selectable input option (e.g., a pop-up window with a selectable “yes” input option and a selectable “no” input option).

In some examples, the AI-agents, their machine learning models, and/or their tools (e.g., deep neural networks, language models, LLMs, SLMs, VLMs, multi-modal language models, perception models, tracking models, fusion models, transformer models, diffusion models, encoder-only models, decoder-only models, encoder-decoder models, neural rendering field (NERF) models, databases, control applications, services, etc.) described herein may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, the agent(s), machine learning model(s), and/or tool(s) may be included within the container itself. In other examples the agent(s), machine learning model(s), and/or tool(s) may be hosted/stored in the cloud (e.g., in a data center) and/or may be hosted on-premises and/or at the edge (e.g., on a local server or computing device, but outside of the container). In such embodiments, the agent(s), machine learning model(s), and/or tool(s) may be accessible via one or more APIs—such as REST APIs. As such, and in some embodiments, the agent(s), machine learning model(s), and/or tool(s) described herein may be deployed as an inference microservice to accelerate deployment on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The agent(s), machine learning model(s), and/or tool(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the agent(s), machine learning model(s), and/or tool(s) (e.g., that has been optimized for high performance inference), an inference runtime software to execute the agent(s), machine learning model(s), and/or tool(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the agent(s), machine learning model(s), and/or tool(s). When replacing or updating, the software that performs the replacement/updating may maintain user configurations of the inference runtime software and enterprise management software.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, video management, operations center oversight and control, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), small language models (SLMs), vision language models (VLMs), and/or multi-modal language models, systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

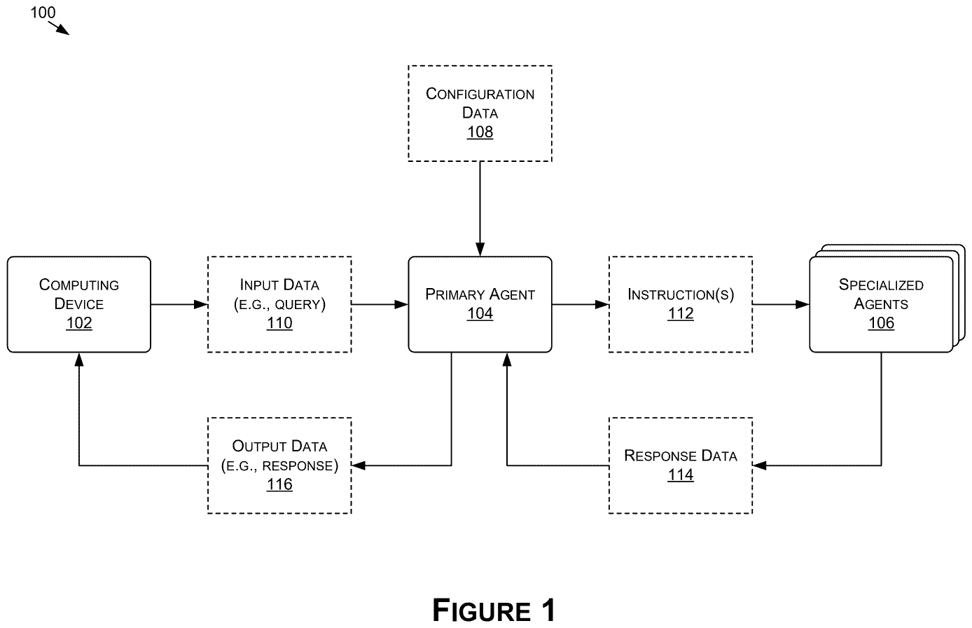

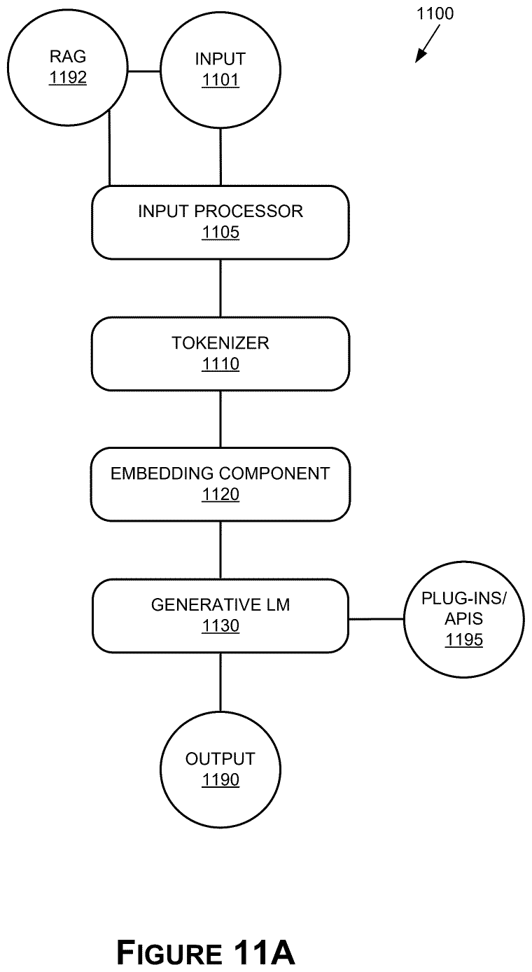

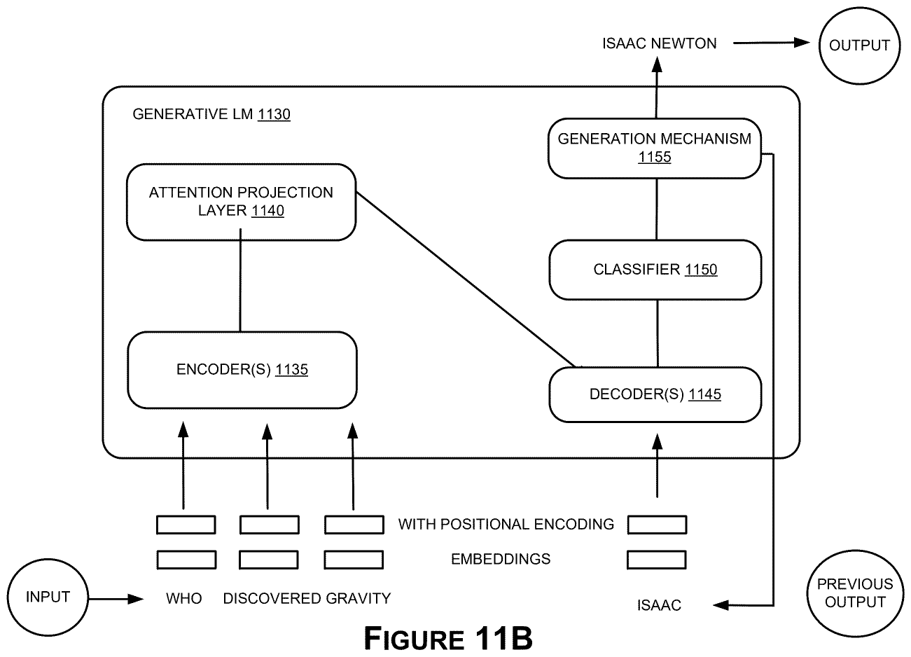

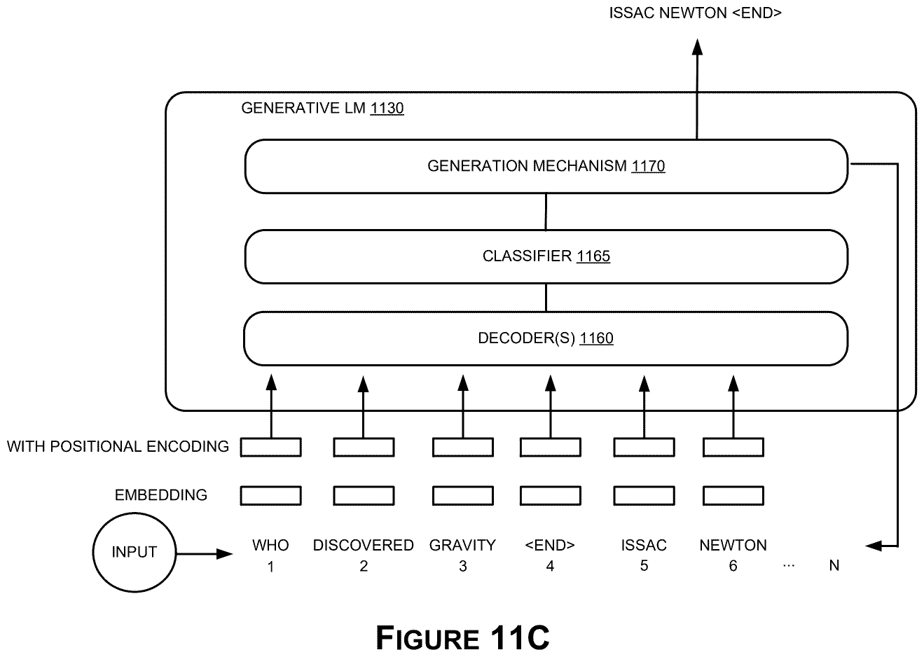

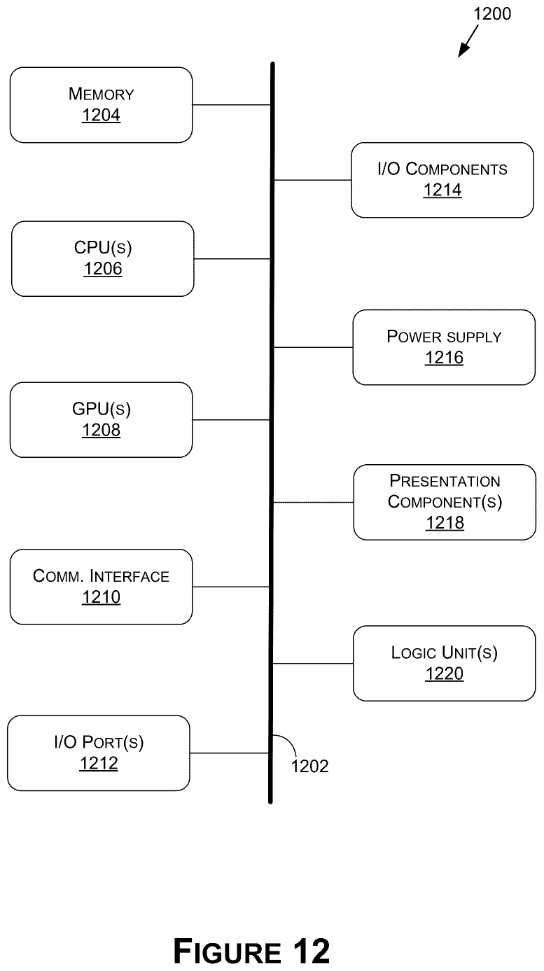

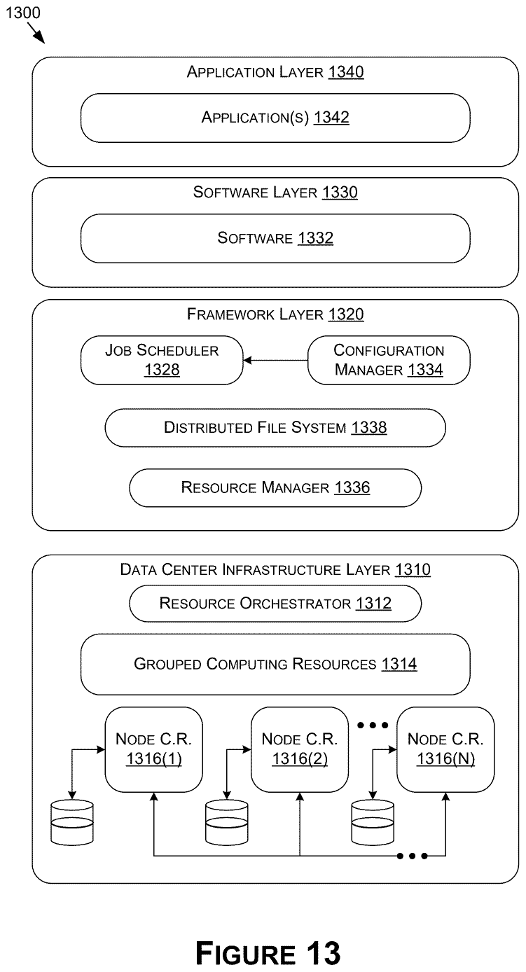

With reference to FIG. 1, FIG. 1 is a data flow diagram illustrating an example of a process 100 for using an AI-based agentic architecture of a user interface to generate a response to a query, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processors executing instructions stored in one or more memories. For example, in some embodiments, the system and methods described herein may be implemented using one or more generative language models (e.g., as described in FIGS. 11A-11C), one or more computing devices or components thereof (e.g., as described in FIG. 12), and/or one or more data centers or components thereof (e.g., as described in FIG. 13).

The process 100 may be implemented using, amongst additional or alternative components, a computing device 102, a primary agent 104, and a plurality of specialized agents 106. As a brief overview, the process 100 may include the primary agent 104 receiving configuration data 108, which may represent a configuration file associated with the multi-agent architecture. The primary agent 104 may use the configuration data 108 as augmentation and/or training data to augment and/or train one or more first language models of the primary agent 104 (and/or, in some embodiments, second language models of the specialized agents 106). Once the primary agent 104 and/or the first language model(s) have been augmented and/or trained, the primary agent 104 may receive input data 110 from the computing device 102. For instance, the computing device 102 may be executing or hosting an instance of a user interface, and the input data 110 may represent a query submitted by a user of the computing device 102 via the user interface. The primary agent 104 may process the input data 110 using the first language model(s) to determine one or more instructions 112 to be sent to one or more of the specialized agents 106. The specialized agents 106 may process the instruction(s) 112 using one or more second language models to determine one or more responses to the instruction(s) 112, which may be represented using the response data 114. The response data 114 may be sent to the primary agent 104, and the primary agent may use the first language model(s) to process, individually and/or in combination, one or more of the input data 110, the instruction(s) 112, and/or the response data 114 to generate output data 116 representing a response to the query represented in the input data 110. The output data 116 may then be sent to the computing device 102 for output.

As described herein, in some examples, the primary agent 104 and/or the first language model(s) of the primary agent 104 may be augmented and/or trained using the configuration data 108, which may include or otherwise represent one or more configuration files associated with the agentic architecture. The configuration data 108 may represent information and/or specifications associated with the multi-agent architecture. For example, the configuration data 108 may indicate, among other things, the uses, capabilities, tools, etc. of each one of the specialized agents 106, sample queries (e.g., sample versions of the instruction(s) 112) for each of the specialized agents 106, network endpoints for the specialized agents 106, and/or other information. As an example, for a video storage agent, the configuration data 108 may indicate that the video storage agent may be used to obtain segments of videos stored in a database, that a sample query may include “obtain the feed of camera 1 from 10:00-10:05 PM on Oct. 10, 2024,” and a valid URL, IP address, etc., for the video storage agent. In some examples, the configuration data 108 may be applied as an augmentation and/or training input to the first language model(s) of the primary agent 104. For instance, the first language model(s) may be augmented and/or trained, using the configuration data 108, to determine relevant ones of the specialized agents 106 to invoke for responding to certain queries included in the input data 110, to generate instructions or sub-queries in a format or schema that is understood by the agents, to reason through complex queries, etc.

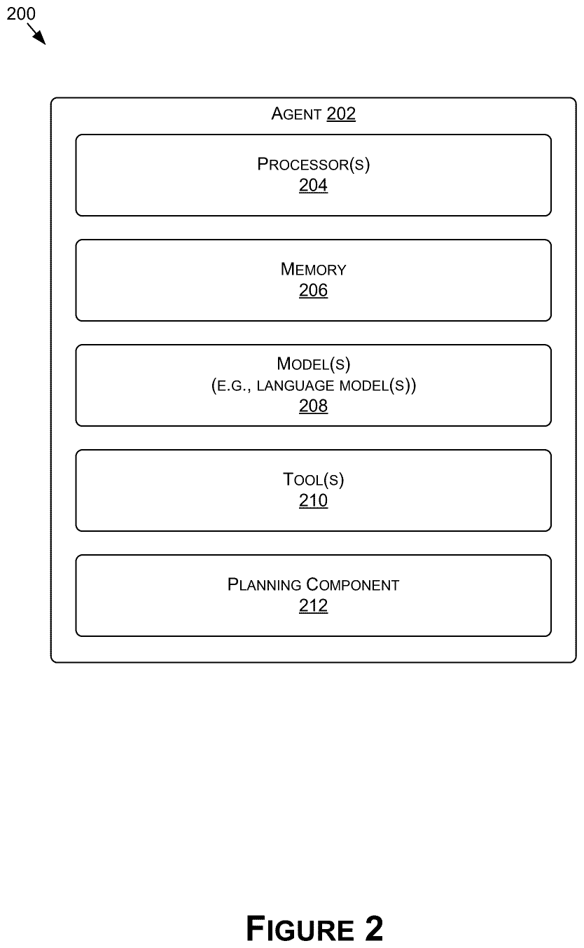

In some examples, the primary agent 104 and/or the specialized agents 106 may include various models, tools, components, and/or other features that enable the agents to collaborate with one another and reason through complex tasks or queries. For instance, FIG. 2 is a block diagram illustrating example detail 200 associated with an agent 202, in accordance with some embodiments of the present disclosure. The agent 202 may correspond to one or more of the primary agent 104 and/or the specialized agents 106 from the example of FIG. 1. As shown in the example of FIG. 2, the agent 202 may include one or more processors 204 that may correspond to any of the processors described herein, memory 206, one or more models 208, one or more tools 210, and a planning component 212.

Although shown as separate from the memory 206, in some examples, the memory 206 may store one or more of the model(s) 208, the tool(s) 210, and/or the planning component 212. In some instances, the memory 206 may serve as a repository for the internal records of the agent 202 and/or the agent's interactions with users and/or other agents. The memory may include short-term memory and/or long-term memory. In some examples, the short-term memory may act as a ledger of the actions and thoughts the agent 202 processes while addressing a specific query, essentially capturing the agent's “train of thought.” In contrast, the long-term memory may function as a logbook that documents ongoing interactions and events between the agent 202 and other agents and/or users, encompassing conversation histories that can extend over weeks or months.

As described herein, the model(s) 208 may include one or more language models that serve as the core engine for understanding and generating human-like text. The model(s) 208 may process inputs by analyzing the context and intent behind queries, drawing on extensive training on diverse text data to produce coherent and contextually relevant responses. By leveraging advanced algorithms, such as those found in Transformer architectures, the model(s) 208 may capture nuanced meanings and relationships between words, allowing it to handle complex language tasks like conversation, summarization, and translation. Essentially, the model(s) 208 may enable the agent 202 to engage in meaningful interactions, adapt to different contexts, and provide informative answers, all while continuously learning from its interactions to enhance future performance. While many of the examples described herein are with respect to using language models, and specifically, large language models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (KNN), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural rendering field (NeRF) models, models with encoder-only architectures, models with decoder-only architectures, models with encoder-decoder architectures, generative machine learning models, language models, large language models (LLMs), small language models (SLMs), vision language models (VLMs), multi-modal language models (MMLMs), etc.), and/or other types of machine learning models.

The tool(s) 210 may represent or include defined, executable workflows that enable the agent 202 to perform various tasks efficiently. These tool(s) 210 may include specialized third-party APIs designed to enhance the capabilities of the agent 202. For example, the tool(s) 210 of the agent 202 may include a Retrieval-Augmented Generation (RAG) pipeline to provide context-aware responses, or a code interpreter to tackle intricate programming challenges. Additionally, the agent 202 may use the tool(s) 210 to access external APIs to search for information online, retrieve real-time data from services such as weather APIs, or interact with instant messaging platforms. By leveraging its tool(s) 210, the agent 202 may expand its functionality, enabling the agent 202 to handle a wide range of inquiries and tasks with greater accuracy and relevance.

The planning component 212 of the agent 202 may be used to address complex issues and queries. To handle such complexity, the planning component 212 may use various different strategies, such as task and question decomposition, reflection, critique, and/or other methods. For instance, when faced with a compound and/or complex question, the planning component 212 may break the question down into simpler parts. As such, the primary agent 104 may break an original query into one or more subqueries to be submitted to the specialized agents 106, and the specialized agents may further break these subqueries down even further. Additionally, the planning component 212 may employ reflection techniques—like ReAct, Reflexion, Chain of Thought, and/or Graph of Thought—to improve reasoning skills and refine the response process. By using these methods, the planning component 212 may enable the agent 202 to effectively tackle intricate queries and provide meaningful, well-informed answers.

Referring back to the example of FIG. 1, the process 100 may include the primary agent 104 receiving or otherwise obtaining the input data 110 representing the query (e.g., a natural language query) or other request for information. The input data 110 may be sent by the computing device 102 that is executing the instance of the user interface associated with an operations center, a command center, a video management system, and/or any other centralized managing and monitoring system. In some instances, the input data 110 may be multimodal. For instance, the input data 110 may include text data representing the query, audio data representing speech containing the query, image data or a stream of image data (e.g., a video) representing an image or video associated with the query, etc. For instance, in the context of image data or the stream of image data, a user may use sign language gestures to sign the query or request.

Additionally, or alternatively, the input data 110 may include additional or supplemental data associated with the query, which may be represented using image data, audio data, video data, and/or any other type of data. In other words, the input data 110 may be multimodal and contain certain portions of data that are additional to the query/request itself. As an example, a user may upload an image and submit a query (e.g., by typing in the query, uttering the query, etc.) associated with the image, such as “which camera captured this image?”, “when was this image taken?”, or “can you obtain the live feed of the camera that took this image?” In such examples, the input data 110 may include image data (corresponding to the additional data and/or the query), as well as text data, audio data, and/or any other data.

In some examples, the primary agent 104 may analyze the query or request represented in the input data 110 and determine a plan for obtaining the requested information or otherwise responding to the query. For instance, the primary agent 104 may use the first language model(s)—which may include one or more LLMs, one or more SLMs, one or more VLMs, one or more multimodal language models, etc.—and/or any other machine learning models, to process the input data 110 and determine the plan. In some instances, the plan may include a subset of the specialized agents 106 that the primary agent 104 may communicate with in order to obtain any necessary information for responding to the query. As an example, if the query states “what is happening right now at camera 1?”, the primary agent 104 may use the first language model(s) to understand the query and decompose the query into one or more tasks that need to be completed in order for the primary agent 104 to respond. In this example, the tasks may include at least obtaining the video feed for the camera from a first agent (e.g., a video storage toolkit (VST) agent) of the specialized agents 106 and analyzing the video feed to determine what is happening or otherwise depicted in the video using a second agent (e.g., a VLM agent) of the specialized agents 106.

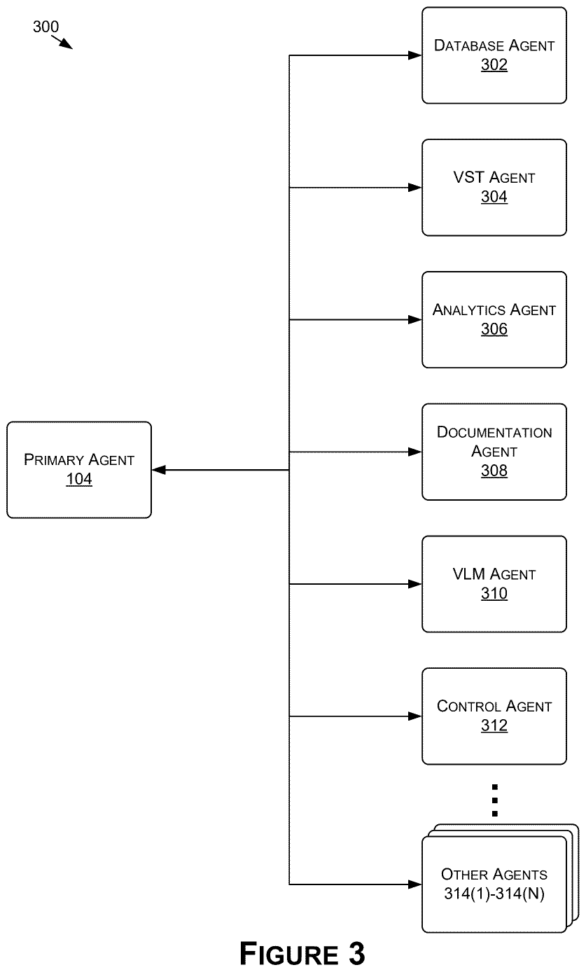

In some examples, the specialized agents 106 may include various types of agents configured to perform various types of operations. For instance, FIG. 3 illustrates an example of a multi-agent architecture 300, in accordance with some embodiments of the present disclosure. The multi-agent architecture 300 may include the primary agent 104 and a plurality of specialized agents, such as a database agent 302, a video storage toolkit (VST) agent 304, an analytics agent 306, a documentation agent 308, a vision language model (VLM) agent 310, a control agent 312, and one or more other agents 314(1)-314(N) (where “N” may represent any number). Although shown as including a single agent of each type, in some examples, the multi-agent architecture 300 may include one or more agents of one or more types, such as one or more of the database agent 302, the VST agent 304, the analytics agent 306, the documentation agent 308, the VLM agent 310, the control agent 312, etc. In some embodiments, at least a portion of the plurality of specialized agents may be aware of other specialized agents and/or may communicate with one or more another.

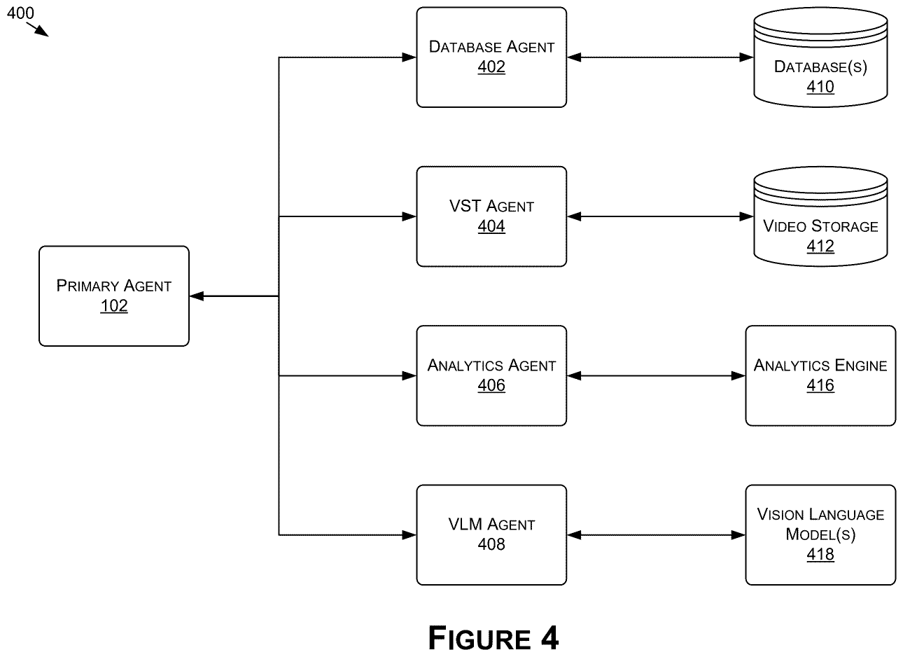

Additionally, the types and/or abilities (e.g., tools) of the specialized agents 106 in the example of FIG. 1 may vary depending on the given architecture/implementation. For instance, FIG. 4 illustrates an example of a multi-agent architecture 400 associated with a video management system, in accordance with some embodiments of the present disclosure. This multi-agent architecture 400 includes a database agent 402, a VST agent 404, an analytics agent 406, and a VLM agent 408, and each of the agents may include or communicate with different tools to respond to instructions or queries received from the primary agent 104. For instance, the database agent 402 may communicate with or include one or more databases 410 (e.g., a relational database(s)), the VST agent 404 may communicate with or include a video storage system 412, the analytics agent 406 may communicate with or include an analytics engine 416, and the VLM agent 408 may communicate with or include one or more vision language models 418.

Referring back to the example of FIG. 1, in some examples, the way in which the primary agent 104 may query the specialized agents 106 to obtain necessary information for responding to queries may vary from one implementation to another implementation and/or vary based on the substance of the query. For example, in some instances the primary agent 104 may simply forward the input data 110 representing the original query (e.g., the query received from the user) to all of, or a subset of, the specialized agents 106. In such an example, the specialized agents 106 may then determine the relevant information they may be able to provide, and provide that information as the response data 114 to the primary agent 104 for generating the response. Additionally, after receiving one or more first responses from the specialized agents 106, the primary agent 104 may analyze the first response(s) and/or information therein to determine if it can respond to the user. If the information is incomplete, the primary agent 104 may send additional queries (e.g., instruction(s) 112) to the specialized agents 106 (which may include some of the information already obtained from some of the agents, additional context, additional requests or instructions, etc.) to obtain the additional information. Once the primary agent 104 determines it has the information it needs, it may then use the information to respond to the query (e.g., send the output data 116 representing the response).

Additionally, or alternatively, in some instances the primary agent 104 may, based on the plan, generate the instruction(s) 112 or sub-queries related to the original query, and send these instruction(s) 112 to the specialized agents 106 and/or a select subset (e.g., one or more) of the specialized agents 106. For instance, based at least on processing the input data 110 and/or the plan using the first language model(s), the primary agent 104 may generate first text data representing the instruction(s) 112 for obtaining the information from the select number of specialized agents 106. In such instances, the primary agent 104 may send a first subset of the instruction(s) 112 to a first subset of the specialized agents 106, a second subset of the instruction(s) 112 to a second subset of the specialized agents 106, and so forth.

In some examples, the plan may indicate that some information may be needed from a first specialized agent before one of the instruction(s) 112 can be submitted to a second specialized agent. Take, for example, the scenario described above in which the query states “what is happening right now at camera 1?” In this example, the primary agent 104 may need to first obtain the video feed from a VST agent of the specialized agents 106 by sending the VST agent first instruction(s), and then forward the video feed and/or second instructions to a VLM agent of the specialized agents 106 for analysis. Additionally, or alternatively, the primary agent 104 may cause the VST agent to forward the video feed directly to the VLM agent (e.g., using the instructions).

As described herein, in various examples, the specialized agents 106 may receive the input data 110 and/or the instruction(s) 112 from the primary agent 104 and process the data using the second language model(s). The specialized agents 106 may use the second language model(s) to process the input data 110 or instruction(s) 112 to understand the query, the instruction(s) 112, and/or the sub-query(ies) (e.g., understand the intent or the specific request). For instance, the specialized agents 106 may analyze this data using the second language model(s) to determine one or more tools to use to obtain the information requested by the primary agent 104. Additionally, using the second language model(s), the specialized agents 106 may, in some instances, convert the input data 110 or the instruction(s) 112 into text data representing one or more API calls, one or more SQL statements or queries, one or more plain-text queries, or any other computer-executable instructions for obtaining the information. The specialized agents 106 may execute the API call(s) and/or send the SQL statements to a relational database for execution to determine or otherwise obtain the information. Upon obtaining the information, in some instances the specialized agents 106 may need to summarize or otherwise reformat the information by converting the information into a natural language sentence(s), phrase(s), etc., so the primary agent 104 may understand the information. As such, the specialized agents 106 may use the second language model(s) to generate the response data 114 corresponding to the information, and then send the response data 114 back to the primary agent 104 as the response to the input data 110 query, the instruction(s) 112, and/or the sub-query(ies).

Additionally, in some examples, the specialized agents 106 may, depending on the query, instruction(s) 112, or sub-query(ies), perform requested operations/tasks in addition to, or in the alternative of, obtaining information for the primary agent 104 to respond to a query. For instance, the primary agent 104 may request the specialized agents 106 to store something in a database, to delete items from the database, to reorganize items in the database, to reformat stored data, update documentation, or perform any other output-type operations. Additionally, in some examples, the specialized agents 106 may include control agents that may control various machines, equipment, resources, building or resource access, etc. As an example, based on receiving a query from a user, the primary agent 104 may invoke a control agent to control one or more operations of one or more machines (e.g., autonomous or semi-autonomous machines). This may include, in some instances, causing one or more autonomous machines or vehicles to use a different path, begin operating, cease operating, navigate to a specific location, or any other operations. Additionally, or alternatively, the control agents may be used to lock or unlock doors of buildings (e.g. to restrict or permit access), turn lighting off or on, operate HVAC systems, operate security cameras (e.g., turn off or on, adjust field of view (e.g., zoom, camera pose, orientation, etc.)), operate sound systems, operate appliances, activate or deactivate alarms, operate manufacturing equipment, or any other operations.

In some instances, these output-type operations may be performed in conjunction with user queries and/or may be performed autonomously and the user interface updated retroactively to inform users of the operations. For instance, assume in a warehouse setting that an aisle or path is blocked such that autonomous machines may not traverse the aisle/path. In such scenarios, the multi-agent architecture may detect the obstruction, update the autonomous machines to use a different path or avoid the obstructed aisle/path, and then send a notification for output by the user interface to notify of the obstruction and the actions taken in response. In other words, the multi-agent architecture and/or one or more agents thereof may detect an event, respond to the event (e.g., deploy machines, lock doors, shut down equipment, record the event, etc.), and then provide this information as response data 114 to the primary agent 104 to generate the output data 116 associated with the event/responses for display on the user interface of the computing device 102.

In some examples, one or more of the specialized agents 106 may be unavailable and the primary agent 104 may dynamically change the plan and/or use other agents in order to respond to the user submitted query. For instance, if one agent is unresponsive or the agent's tools are unavailable (e.g., database is inaccessible, etc.), the unavailable agent may send a response to the primary agent 104 to inform the primary agent 104 of the condition. Upon receiving the response, the primary agent 104 may determine to send the input data 110 and/or instruction(s) 112 to a backup or alternative agent that has the same or similar tools. Alternatively, or additionally, if no such backup agent exists, the primary agent 104 may determine whether it is possible to adequately respond to the query without the information. If it is not possible to respond, the primary agent 104 may send such a response to the computing device 102 indicating that the query cannot be completed.

In some examples, the primary agent 104 may receive the response data 114 from the specialized agents 106, which may include the necessary information for responding to the original query. The primary agent 104 may use the first language model(s) to process the information available to it to generate the response included in the output data 116. For instance, the primary agent 104 may process, using the first language model(s), text data corresponding to one or more of the input data 110, the instruction(s) 112, the response data 114, and/or other data to generate the response to the query. In some examples, the output data 116 may include a multimodal response and the primary agent 104 may use the first language model(s) to generate a textual portion of the multimodal response. For instance, the output data 116 may include audio data, image data, video data, text data, and/or any other kind of data, and the first language model(s) may generate the text data portion. Additionally, or alternatively, the primary agent 104 may use a multimodal language model (MMLM) to generate the output data 116. As an example of a multimodal response, the response may include one or more of text representing a natural language sentence(s), an image (e.g., an image of a camera of a video management system), a segment of a video, audio recorded in conjunction with the video, a link to the image or the video, etc.

The primary agent 104 may send, to the computing device 102 executing the instance of the user interface, the output data 116 corresponding to the response to the query. In some examples, the output data may cause the computing device 102 to cause presentation of the response (e.g., the multimodal response). For instance, the computing device 102 may cause presentation of the response by displaying, on the user interface, the text data representing the natural language response, image data, videos, or any other data that may be visualized. Additionally, in some examples, the computing device 102 may cause presentation of the response audibly using one or more speakers connected to the computing device 102. In some examples, the multi-agent architecture may include or use text to speech and/or automatic speech recognition (ASR) engines (not shown) for converting text data to audio data and/or converting audio data representing speech to text data. In some examples, the output data 116 may further include one or more selectable options, input fields, and/or other forms of receiving additional user input related to the response to the query. For instance, if an initial query recites “is camera 1 active?”, the response to the query may include text data that recites “yes, camera 1 is active, would you like to see the video feed?” along with a selectable input option (e.g., a pop-up window with a selectable “yes” input option and a selectable “no” input option).

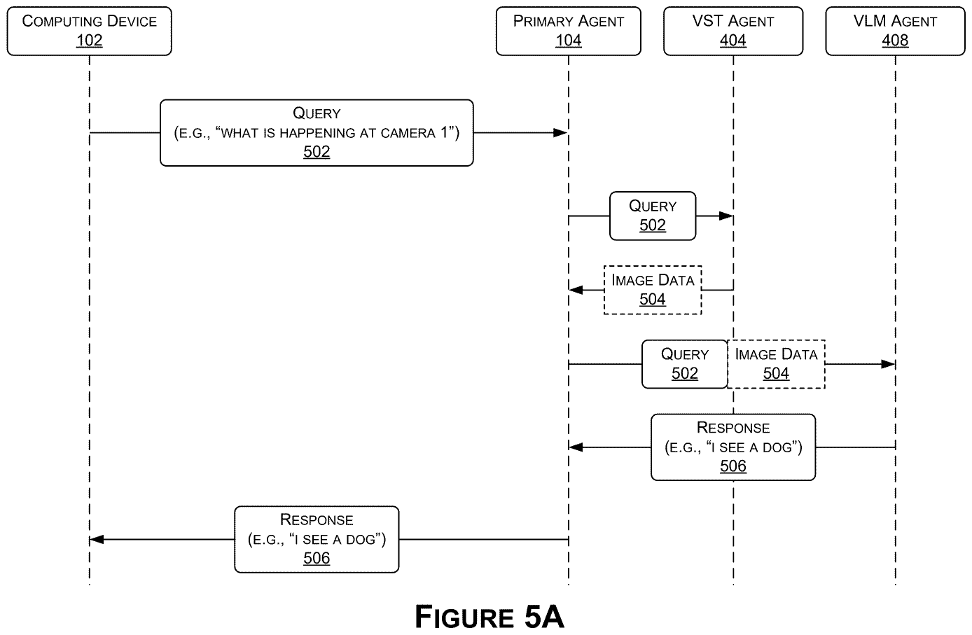

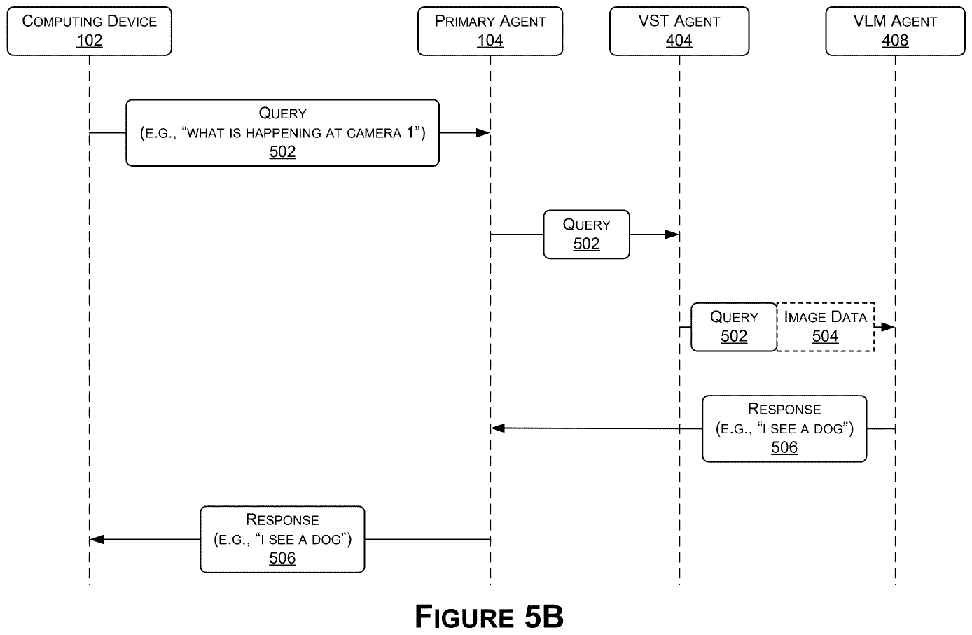

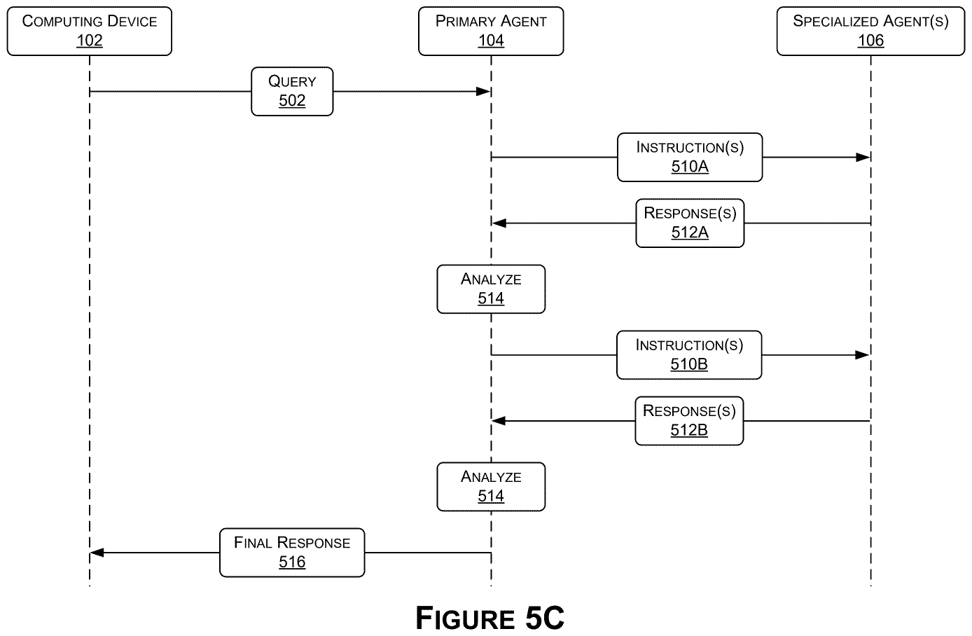

FIGS. 5A-5C are data flow diagrams illustrating various examples of ways in which a primary agent may communicate with a plurality of specialized agents to respond to a query, in accordance with some embodiments of the present disclosure. The examples illustrate a primary agent interacting with two specialized agents; however, these are merely illustrative. The primary agent may interact with any number of additional specialized agents, depending on query, context, and/or system requirements. Further, in some embodiments, the specialized agents may interact with each other. Referring first to the example of FIG. 5A, the computing device 102 may send a query 502 to the primary agent 104. As shown, the query may ask “what is happening at camera 1?” The primary agent 104 may obtain the query 502 and determine a plan for responding. For instance, the primary agent 104 may decompose the initial query and determine that to respond to the query it needs to (a) obtain the video feed of camera 1 and (b) analyze the video feed to determine what is happening. As such, the primary agent may forward the query 502 to the VST agent 404, which may, in response, send image data 504 (e.g., the video feed for camera 1) to the primary agent 104. The primary agent 104 may then forward the query 502 and the image 504 to the VLM agent 408. The VLM agent 408 may analyze the image data 504 using one or more VLMs to determine what is happening at camera 1. The VLM agent 408 may generate a response 506 based on the query 502 and the image data 504. For instance, if the image data 504 represents an image or video depicting a dog in the field of view of the camera 1, the response 506 may include text that says “I see a dog.” The primary agent 104 may forward the response 506 to the computing device 102 for output via the user interface.

Referring now to the example of FIG. 5B, the computing device 102 may send the query 502 to the primary agent 104. The primary agent 104 may obtain the query 502 and determine a plan for responding. For instance, the primary agent 104 may decompose the initial query and determine that to respond to the query it needs to (a) obtain the video feed of camera 1 and (b) analyze the video feed to determine what is happening. As such, the primary agent may determine that the VST agent 404 needs to be invoked first and forward the query 502 to the VST agent 404. In response, the VST agent 404 may analyze the query 502 and obtain image data 504 (e.g., the video feed for camera 1). The VST agent 404 may then forward the query 502 and the image data 504 to the VLM agent 408 for understanding what is happening in the video feed. The VLM agent 408 may analyze the image data 504 using one or more VLMs to determine what is happening at camera 1. The VLM agent 408 may analyze the image data 504 in light of the query 502 to determine what is happening in the scene depicted in the video feed represented by the image data 504. The VLM agent may then generate the response 506 based on the query 502 and the image data 504, and forward the response 506 to be received by the primary agent 104 (e.g., directly, or indirectly via the VST agent 404). The primary agent 104 may forward the response 506 to the computing device 102 for output via the user interface.

Referring now to FIG. 5C, the computing device 102 may send the query 502 to the primary agent 104. In the example shown in FIG. 5C, the primary agent 104 may generate one or more first instructions 510 (e.g., using one or more first language models) and send the first instruction(s) 510A to the specialized agent(s) 106. In some examples, the primary agent 104 may send the first instruction(s) 510A to each one of the specialized agent(s) 106 and/or to a subset of the specialized agent(s) 106. The specialized agent(s) 106 may process the first instruction(s) 510A (e.g., using one or more second language models) and generate one or more first responses 512A. The primary agent 104 may analyze 514 the first response(s) 512A to determine whether it has sufficient information to respond to the query 502. In some examples, the primary agent 104 may, based on the analysis of the first response(s) 512A with respect to the query 502, the primary agent 104 may generate and send one or more second instruction(s) 510B to the specialized agent(s) 106. In some examples, the primary agent 104 may send the second instruction(s) 510B to each one of the specialized agent(s) 106 and/or to a subset of the specialized agent(s) 106. The specialized agent(s) 106 may process the second instruction(s) 510B (e.g., using one or more second language models) and generate one or more second responses 512B. The primary agent 104 may analyze 514 the second response(s) 512B and/or the first response(s) 512A to determine whether it has sufficient information to respond to the query 502. For instance, the primary agent 104 may process the query 502, the first and second instruction(s) 510A and 510B, and/or the first and second response(s) 512A and 512B using the first language model(s) to generate a final response 516 to the query 502. In some examples, the final response 516 may include a multimodal response as described herein.

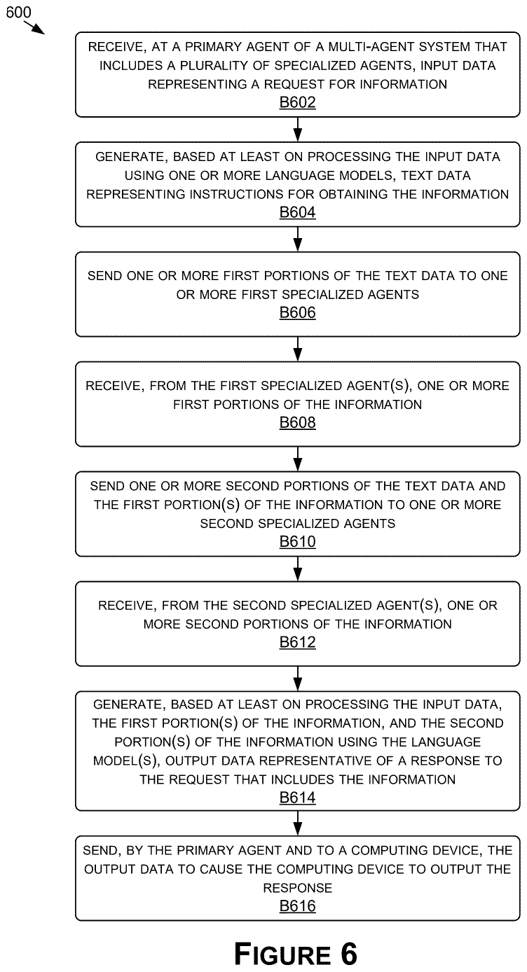

Now referring to FIGS. 6-10, each block of methods 600-1000, described herein, comprises a computing process that may be performed using any combination of hardware, firmware, and/or software. For instance, various functions may be carried out using one or more processors executing instructions stored in one or more memories. The methods may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, methods 600-1000 are described, by way of example, with respect to the system of FIG. 1. However, these methods may additionally or alternatively be executed by any one system, or any combination of systems, including, but not limited to, those described herein.

FIG. 6 is a flow diagram illustrating an example of a method 600 that may be implemented by a multi-agent architecture to respond to a query, in accordance with some embodiments of the present disclosure. The method 600, at block B602, includes receiving, at a primary agent of a multi-agent system that includes a plurality of specialized agents, input data representing a request for information. For instance, the primary agent 104 may receive the input data 110 representing the request for the information.

The method 600, at block B604, includes generating, based at least on processing the input data using one or more language models, text data representing instructions for obtaining the information. For instance, the primary agent 104 may generate, based at least on processing the input data 110 using the language model(s), the text data representing the instruction(s) 112 for obtaining the information.

The method 600, at block B606, includes sending one or more first portions of the text data to one or more first specialized agents. For instance, the primary agent 104 may send the first portion(s) of the text data to the first specialized agent(s) of the specialized agents 106. The method 600, at block B608, includes receiving, from the first specialized agent(s), one or more first portions of the information. For instance, the primary agent 104 may receive, from the first specialized agent(s) of the specialized agents 106, the first portions of the information, which may be included in the response data 114.

The method 600, at block B610, includes sending one or more second portions of the text data and the first portion(s) of the information to one or more second specialized agents. For instance, the primary agent 104 may send the second portions of the text data and the first portion(s) of the information to the second specialized agent(s) of the specialized agents 106. The method 600, at block B612, includes receiving, from the second specialized agent(s), one or more second portions of the information. For instance, the primary agent 104 may receive the second portion(s) of the information, which may be included in the response data 114, from the second specialized agent(s) of the specialized agents 106.

The method 600, at block B614, includes generating, based at least on processing the input data, the first portion(s) of the information, and the second portion(s) of the information using the language model(s), output data representative of a response to the request that includes the information. For example, based at least on based at least on processing the input data 110, the instruction(s) 112, the first portion(s) of the information, and/or the second portion(s) of the information using the language model(s), the primary agent 104 may generate the output data 116 representative of the response to the request that includes the information.

The method 600, at block B616, includes sending, by the primary agent and to a computing device, the output data to cause the computing device to output the response. For instance, the primary agent 104 may send the output data 116 to the computing device 102, and the output data 116 may cause the computing device 102 to output the response to the request (e.g., via a user interface).

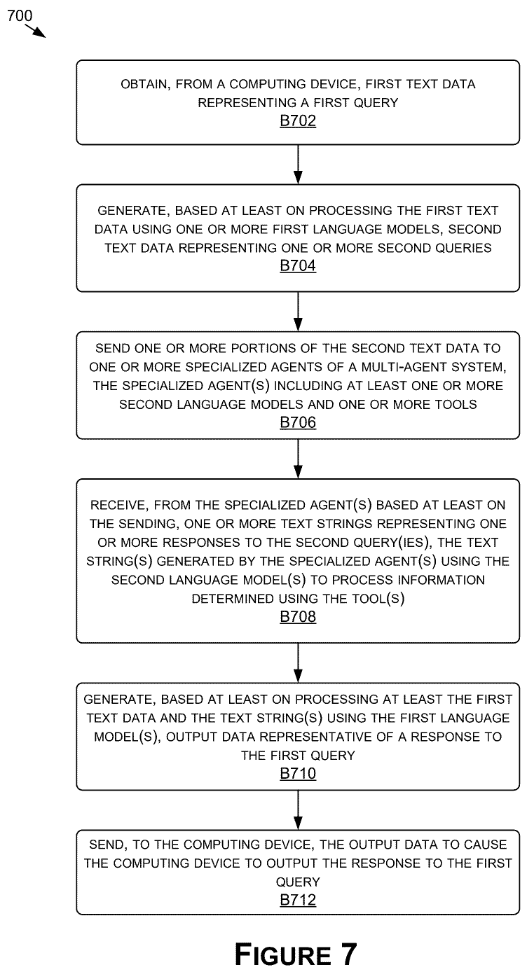

FIG. 7 is a flow diagram illustrating an example of a method 700 for responding to a query using an AI-based agentic architecture, in accordance with some embodiments of the present disclosure. The method 700, at block B702, includes obtaining, from a computing device, first text data representing a first query. For instance, the primary agent 104 may obtain, from the computing device 102, the input data 110 which includes first text data representing the first query.

The method 700, at block B704, includes generating, based at least on processing the first text data using one or more first language models, second text data representing one or more second queries. For instance, the primary agent 104 may generate the instruction(s) 112, which may include the second text data representing the second query(ies). In some instances, the primary agent 104 may generate the second text data using a first language model to process the first text data.

The method 700, at block B706, includes sending one or more portions of the second text data to one or more specialized agents of a multi-agent system, the specialized agent(s) including at least one or more second language models and one or more tools. For instance, the primary agent may send the portion(s) of the second text data to the specialized agent(s) of the specialized agents 106.

The method 700, at block B708, includes receiving, from the specialized agent(s) based at least on the sending, one or more text strings representing one or more responses to the second query(ies), the text string(s) generated by the specialized agent(s) using the second language model(s) to process information determined using the tool(s). For instance, the primary agent 104 may receive, from the specialized agent(s) of the specialized agents 106, the text string(s) representing the response(s) to the second query(ies). In some examples, the specialized agent(s) may generate the text string(s) using the second language model(s) to process the information determined using the tool(s).

The method 700, at block B710, includes generating, based at least on processing at least the first text data and the text string(s) using the first language model(s), output data representative of a response to the first query. For instance, the primary agent 104 may generate, based at least on processing at least the first text data and the text string(s) using the first language model(s), the output data 116 representative of the response to the first query. The method 700, at block B712, includes sending, to the computing device, the output data to cause the computing device to output the response to the first query. For instance, the primary agent 104 may send, to the computing device 102, the output data 116 to cause the computing device 102 to output the response to the first query.

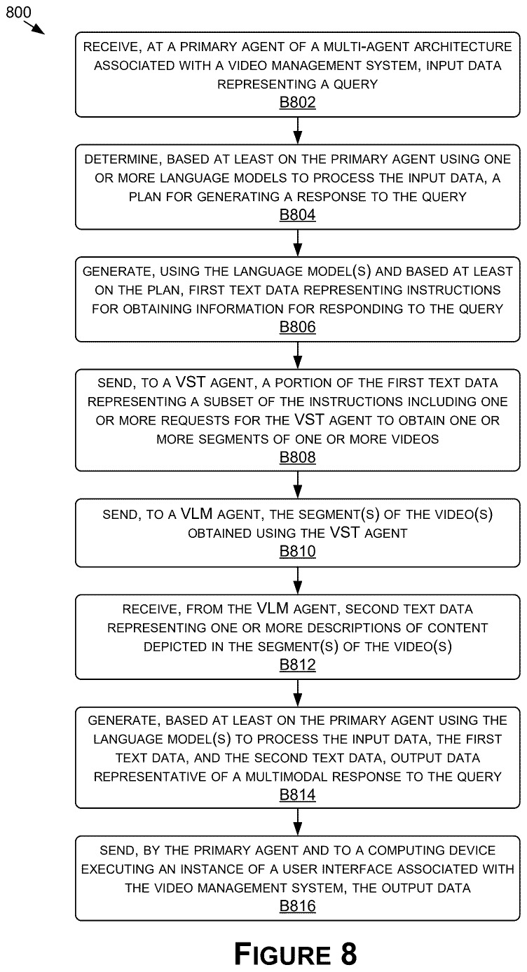

FIG. 8 is a flow diagram illustrating an example of a method 800 that may be implemented by a multi-agent architecture for a video management system, in accordance with some embodiments of the present disclosure. The method 800, at block B802, may include receiving, at a primary agent of a multi-agent architecture associated with a video management system, input data representing a query. For instance, the primary agent 104 may receive the input data 110 representing the query. In some examples, the input data 110 may be multimodal and include one or more of text data, audio data, image data, etc.

The method 800, at block B804, may include determining, based at least on the primary agent using one or more language models to process the input data, a plan for generating a response to the query. For instance, the primary agent 104 may determine a plan for generating the response to the query based at least on using the language model(s) to process the input data 110.

The method 800, at block B806, may include generating, using the language model(s) and based at least on the plan, first text data representing instructions for obtaining information for responding to the query. For instance, the primary agent 104 may generate the first text data representing the instruction(s) 112 for obtaining the information for responding to the query. In some examples, the primary agent 104 may generate the first text data using the language model(s).

The method 800, at block B808, may include sending, to a VST agent, a portion of the first text data representing a subset of the instructions including one or more requests for the VST agent to obtain one or more segments of one or more videos. For instance, the primary agent 104 may send, to the VST agent 404, the portion of the first text data representing a subset of the instruction(s) 112. The subset of the instruction(s) 112 may include the request(s) for the VST agent 404 to obtain the segment(s) of the video(s).

The method 800, at block B810, may include sending, to a VLM agent, the segment(s) of the video(s) obtained using the VST agent. For instance, the primary agent 104 may send, to the VLM agent 408, the segment(s) of the video(s) obtained using the VST agent 404. The method 800, at block B812, may include receiving, from the VLM agent, second text data representing one or more descriptions of content depicted in the segment(s) of the video(s). For instance, the primary agent 104 may receive, from the VLM agent 408, the second text data (e.g., the response data 114) representing the description(s) of the content depicted in the segment(s) of the video(s) (e.g., or frames of image data). For instance, if the segment(s) of the video(s) depicts a dog, then the second text data may include a response that says “I see a dog.”

The method 800, at block B814, may include generating, based at least on the primary agent using the language model(s) to process the input data, the first text data, and the second text data, output data representative of a multimodal response to the query. For instance, the primary agent 104 may use the language model(s) to process the input data 110, the first text data, and the second text data. Based on this processing, the primary agent 104 may, using the language model(s), generate the output data 116 representing the multimodal response.

The method 800, at block B816, may include sending, by the primary agent and to a computing device executing an instance of a user interface associated with the video management system, the output data. For instance, the primary agent 104 may send the output data 116 to the computing device 102, which may be executing the instance of the user interface associated with the video management system.

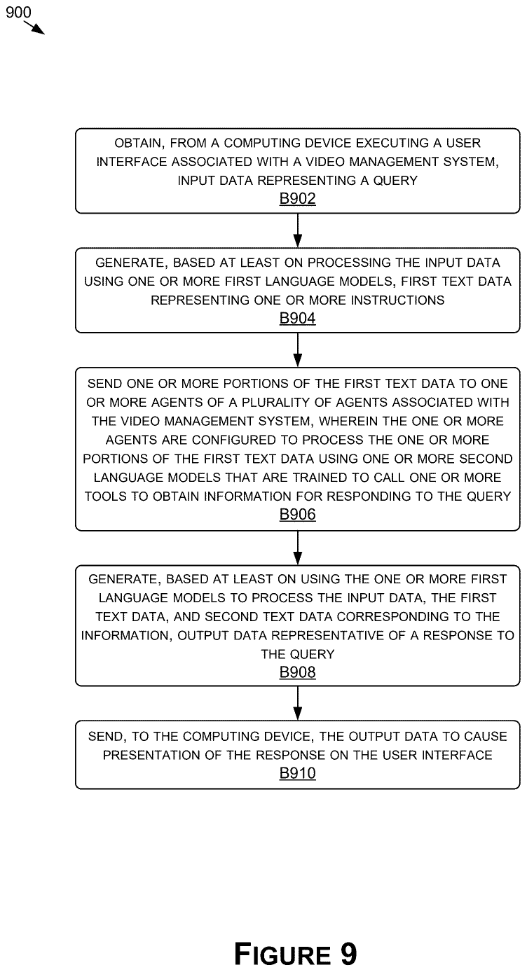

FIG. 9 is a flow diagram illustrating an example of a method 900 for responding to a query using an AI-based agent architecture associated with a video management system, in accordance with some embodiments of the present disclosure. The method 900, at block B902, may include obtaining, from a computing device executing a user interface associated with a video management system, input data representing a query. For instance, the primary agent 104 may obtain the input data 110 from the computing device 102, which may be executing the user interface for the video management system.

The method 900, at block B904, may include generating, based at least on processing the input data using one or more first language models, first text data representing one or more instructions. For instance, the primary agent 104 may generate the first text data representing the instruction(s) 112 based at least on processing the input data 110 using the first language model(s).

The method 900, at block B906, may include sending one or more portions of the first text data to one or more agents of a plurality of agents associated with the video management system, wherein the one or more agents are configured to process the one or more portions of the first text data using one or more second language models that are trained to call one or more tools to obtain information for responding to the query. For instance, the primary agent 104 may send the portion(s) of the first text data (e.g., a subset of the instruction(s) 112) to the agent(s) of the specialized agents 106 of the video management systems. In some examples, the agents of the video management system may include one or more of the specialized agents 106 described herein with respect to the example of FIG. 4, or any other agents described herein.

The method 900, at block B908, may include generating, based at least on using the one or more first language models to process the input data, the first text data, and second text data corresponding to the information, output data representative of a response to the query. For instance, the primary agent 104 may generate the output data 116 representative of the response to the query based at least on using the first language model(s) to process the input data 110, the first text data, and/or the second text data.

The method 900, at block B910, may include sending, to the computing device, the output data to cause presentation of the response on the user interface. For instance, the primary agent 104 may send the output data 116 to the computing device 102, and the output data 116 may cause the computing device 102 to cause presentation of the response on the user interface.

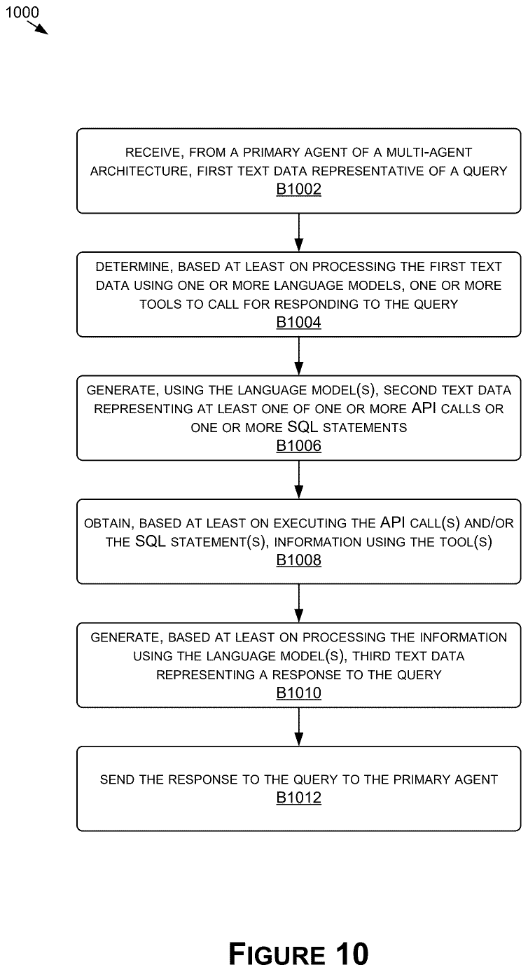

FIG. 10 is a flow diagram illustrating an example of a method 1000 that may be performed by an AI-based agent to respond to instructions received from a primary agent, in accordance with some embodiments of the present disclosure. The method 1000, at block B1002, may include receiving, from a primary agent of a multi-agent architecture, first text data representative of a query. For instance, a specialized agent of the specialized agents 106 may receive, from the primary agent 104, the first text data representative of the query.

The method 1000, at block B1004, may include determining, based at least on processing the first text data using one or more language models, one or more tools to call for responding to the query. For instance, the specialized agent of the specialized agents 106 may determine the tool(s) to call for responding to the query based at least on processing the first text data using the language model(s), which may be trained to call the tool(s) for responding to various queries.

The method 1000, at block B1006, may include generating, using the language model(s), second text data representing at least one of one or more API calls or one or more SQL statements. For instance, the specialized agent of the specialized agents 106 may generate the second text data representing the API call(s) and/or the SQL statement(s) using the language model(s). The method 1000, at block B1008, may include obtaining, based at least on executing the API call(s) and/or the SQL statement(s), information using the tool(s). For instance, the specialized agent of the specialized agents 106 may obtain the information using the tool(s) based at least on executing the API call(s) and/or the SQL statement(s) (e.g., sending the SQL statement(s) to a relational database(s) for execution).

The method 1000, at block B1010, may include generating, based at least on processing the information using the language model(s), third text data representing a response to the query. For instance, the specialized agent of the specialized agents 106 may generate the third text data (e.g., response data 114) representing the response to the query based at least on processing the information using the language model(s). Additionally, the method 1000, at block B1012, may include sending the response to the query to the primary agent. For instance, the specialized agent of the specialized agents 106 may send the response data 114 to the primary agent 104.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### EXAMPLE LANGUAGE MODELS

In at least some embodiments, language models, such as large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/SLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/SLMs/VLMs/MMLMs/etc.

In various embodiments, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/SLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 11A is a block diagram of an example generative language model system 1100 suitable for use in implementing at least some embodiments of the present disclosure. In the example illustrated in FIG. 11A, the generative language model system 1100 includes a retrieval augmented generation (RAG) component 1192, an input processor 1105, a tokenizer 1110, an embedding component 1120, plug-ins/APIs 1195, and a generative language model (LM) 1130 (which may include an LLM, a SLM, a VLM, a multi-modal LM, etc.).

At a high level, the input processor 1105 may receive an input 1101 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 1130 (e.g., LLM/SLMs/VLM/MMLM/etc.). In some embodiments, the input 1101 includes plain text in the form of one or more sentences, paragraphs, and/or documents. Additionally or alternatively, the input 1101 may include numerical sequences, precomputed embeddings (e.g., word or sentence embeddings), and/or structured data (e.g., in tabular formats, JSON, or XML). In some implementations in which the generative LM 1130 is capable of processing multi-modal inputs, the input 1101 may combine text (or may omit text) with image data, audio data, video data, design data, USD data, and/or other types of input data, such as but not limited to those described herein. Taking raw input text as an example, the input processor 1105 may prepare raw input text in various ways. For example, the input processor 1105 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1105 may remove stopwords to reduce noise and focus the generative LM 1130 on more meaningful content. The input processor 1105 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1192 (which may include one or more RAG models, and/or may be performed using the generative LM 1130 itself) may be used to retrieve additional information to be used as part of the input 1101 or prompt. RAG may be used to enhance the input to the LLM/SLM/VLM/MMLM/etc. with external knowledge, so that answers to specific questions or queries or requests are more relevant—such as in a case where specific knowledge is required. The RAG component 1192 may fetch this additional information (e.g., grounding information, such as grounding text/image/video/audio/USD/CAD/etc.) from one or more external sources, which can then be fed to the LLM/SLMs/VLM/MMLM/etc. along with the prompt to improve accuracy of the responses or outputs of the model.

For example, in some embodiments, the input 1101 may be generated using the query or input to the model (e.g., a question, a request, etc.) in addition to data retrieved using the RAG component 1192. In some embodiments, the input processor 1105 may analyze the input 1101 and communicate with the RAG component 1192 (or the RAG component 1192 may be part of the input processor 1105, in embodiments) in order to identify relevant text and/or other data to provide to the generative LM 1130 as additional context or sources of information from which to identify the response, answer, or output 1190, generally. For example, where the input indicates that the user is interested in a desired tire pressure for a particular make and model of vehicle, the RAG component 1192 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1192 may retrieve a prior stored conversation history—or at least a summary thereof—and include the prior conversation history along with the current ask/request as part of the input 1101 to the generative LM 1130.

The RAG component 1192 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1192 and the embeddings of the chunks along with the embeddings of the query may be compared to identify the most similar/related embeddings to the query, which may be supplied to the generative LM 1130 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1192 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1110 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1130 to understand morphological variations and handle out-of-vocabulary words more effectively. Character-based tokenization represents each character as a separate token, enabling the generative LM 1130 to process text at a fine-grained level. The choice of tokenization strategy may depend on factors such as the language being processed, the task at hand, and/or characteristics of the training dataset. As such, the tokenizer 1110 may convert the (e.g., processed) text into a structured format according to tokenization schema being implemented in the particular embodiment.

The embedding component 1120 may use any known embedding technique to transform discrete tokens into (e.g., dense, continuous vector) representations of semantic meaning. For example, the embedding component 1120 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1101 includes image data/video data/etc., the input processor 1101 may resize the data to a standard size compatible with format of a corresponding input channel and/or may normalize pixel values to a common range (e.g., 0 to 1) to ensure a consistent representation, and the embedding component 1120 may encode the image data using any known technique (e.g., using one or more convolutional neural networks (CNNs) to extract visual features). In some implementations in which the input 1101 includes audio data, the input processor 1101 may resample an audio file to a consistent sampling rate for uniform processing, and the embedding component 1120 may use any known technique to extract and encode audio features—such as in the form of a spectrogram (e.g., a mel-spectrogram). In some implementations in which the input 1101 includes video data, the input processor 1101 may extract frames or apply resizing to extracted frames, and the embedding component 1120 may extract features such as optical flow embeddings or video embeddings and/or may encode temporal information or sequences of frames. In some implementations in which the input 1101 includes multi-modal data, the embedding component 1120 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1130 and/or other components of the generative LM system 1100 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1120 may apply an encoded representation of the input 1101 to the generative LM 1130, and the generative LM 1130 may process the encoded representation of the input 1101 to generate an output 1190, which may include responsive text and/or other types of data.

As described herein, in some embodiments, the generative LM 1130 may be configured to access or use—or capable of accessing or using—plug-ins/APIs 1195 (which may include one or more plug-ins, application programming interfaces (APIs), databases, data stores, repositories, etc.). For example, for certain tasks or operations that the generative LM 1130 is not ideally suited for, the model may have instructions (e.g., as a result of training, and/or based on instructions in a given prompt, such as those retrieved using the RAG component 1192) to access one or more plug-ins/APIs 1195 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1195 to the plug-in/API 1195, the plug-in/API 1195 may process the information and return an answer to the generative LM 1130, and the generative LM 1130 may use the response to generate the output 1190. This process may be repeated—e.g., recursively—for any number of iterations and using any number of plug-ins/APIs 1195 until an output 1190 that addresses each ask/question/request/process/operation/etc. from the input 1101 can be generated. As such, the model(s) may not only rely on its own knowledge from training on a large dataset(s) and/or from data retrieved using the RAG component 1192, but also on the expertise or optimized nature of one or more external resources—such as the plug-ins/APIs 1195.

FIG. 11B is a block diagram of an example implementation in which the generative LM 1130 includes a transformer encoder-decoder. For example, assume input text such as “Who discovered gravity” is tokenized (e.g., by the tokenizer 1110 of FIG. 11A) into tokens such as words, and each token is encoded (e.g., by the embedding component 1120 of FIG. 911A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1135 of the generative LM 1130.

In an example implementation, the encoder(s) 1135 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1140 may convert the context vector into attention vectors (keys and values) for the decoder(s) 1145.

In an example implementation, the decoder(s) 1145 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1135, in an example transformer architecture, each token (e.g., word) flows through a separate path in the decoder(s) 1145. During a first pass, the decoder(s) 1145, a classifier 1150, and a generation mechanism 1155 may generate a first token, and the generation mechanism 1155 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1145 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1135, except that it creates its queries from the layer below it and takes the keys and values (e.g., matrix) from the output of the encoder(s) 1135.

As such, the decoder(s) 1145 may output some decoded (e.g., vector) representation of the input being applied during a particular pass. The classifier 1150 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1155 may select or sample a word or token based on a corresponding predicted probability (e.g., select the word with the highest predicted probability) and append it to the output from a previous pass, generating each word or token sequentially. The generation mechanism 1155 may repeat the process, triggering successive decoder inputs and corresponding predictions until selecting or sampling a symbol or token that represents the end of the response, at which point, the generation mechanism 1155 may output the generated response.

FIG. 11C is a block diagram of an example implementation in which the generative LM 1130 includes a decoder-only transformer architecture. For example, the decoder(s) 1160 of FIG. 11C may operate similarly as the decoder(s) 1145 of FIG. 11B except each of the decoder(s) 1160 of FIG. 11C omits the encoder-decoder self-attention layer (since there is no encoder in this implementation). As such, the decoder(s) 1160 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1160. As with the decoder(s) 1145 of FIG. 11B, each token (e.g., word) may flow through a separate path in the decoder(s) 1160, and the decoder(s) 1160, a classifier 1165, and a generation mechanism 1170 may use auto-regression to sequentially generate one token at a time until predicting a symbol or token that represents the end of the response. The classifier 1165 and the generation mechanism 1170 may operate similarly as the classifier 1150 and the generation mechanism 1155 of FIG. 11B, with the generation mechanism 1170 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 12 is a block diagram of an example computing device(s) 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output components 1214, a power supply 1216, one or more presentation components 1218 (e.g., display(s)), and one or more logic units 1220. In at least one embodiment, the computing device(s) 1200 may comprise one or more virtual machines (VMs), and/or any of the components thereof may comprise virtual components (e.g., virtual hardware components). For non-limiting examples, one or more of the GPUs 1208 may comprise one or more vGPUs, one or more of the CPUs 1206 may comprise one or more vCPUs, and/or one or more of the logic units 1220 may comprise one or more virtual logic units. As such, a computing device(s) 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPUs 1208, the CPUs 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1206 may be directly connected to the memory 1204. Further, the CPU 1206 may be directly connected to the GPU 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPUs 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes and/or portions thereof. One or more of the logic units 1220 may be part of and/or integrated in one or more of the CPU(s) 1206 and/or the GPU(s) 1208 and/or one or more of the logic units 1220 may be discrete components or otherwise external to the CPU(s) 1206 and/or the GPU(s) 1208. In embodiments, one or more of the logic units 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, included wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O ports 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may be include depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertia measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiments of the present disclosure. The data center 1300 may include a data center infrastructure layer 1310, a framework layer 1320, a software layer 1330, and/or an application layer 1340. In some examples, the agents described herein may be hosted or run on infrastructure of the data center 1300 and/or similar to that of the data center 1300.

As shown in FIG. 13, the data center infrastructure layer 1310 may include a resource orchestrator 1312, grouped computing resources 1314, and node computing resources (“node C.R.s”) 1316(1)-1316(N), where “N” represents any whole, positive integer. In at least one embodiment, node C.R.s 1316(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1316(1)-1316(N) may correspond to a server having one or more of the above-mentioned computing resources. In addition, in some embodiments, the node C.R.s 1316(1)-13161(N) may include one or more virtual components, such as vGPUs, vCPUs, and/or the like, and/or one or more of the node C.R.s 1316(1)-1316(N) may correspond to a virtual machine (VM).

In at least one embodiment, grouped computing resources 1314 may include separate groupings of node C.R.s 1316 housed within one or more racks (not shown), or many racks housed in data centers at various geographical locations (also not shown). Separate groupings of node C.R.s 1316 within grouped computing resources 1314 may include grouped compute, network, memory or storage resources that may be configured or allocated to support one or more workloads. In at least one embodiment, several node C.R.s 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node C.R.s 1316(1)-1316(N) and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resource 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node C.R.s 1316(1)-1316(N), grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node C.R.s 1316(1)-1316(N), grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: generating, based at least on a primary agent of a multi-agent architecture associated with a video management system using one or more language models to process input data representing a query, first text data representing instructions for obtaining information for responding to the query; sending, to a video storage toolkit (VST) agent of the multi-agent architecture, at least a portion of the first text data representing at least a subset of the instructions, the subset of the instructions including one or more requests for the VST agent to obtain one or more segments of one or more videos; sending, to a vision language model (VLM) agent of the multi-agent architecture, the one or more segments of the one or more videos obtained using the VST agent; receiving, from the VLM agent and based at least on the VLM agent using one or more VLMs to process the one or more segments of the one or more videos, second text data representing one or more descriptions of content depicted in the one or more segments of the one or more videos; generating, based at least on the primary agent using the one or more language models to process at least the first text data and the second text data, output data representative of a multimodal response to the query; and sending, using the primary agent and to a computing device, the output data.

B. The method of paragraph A, further comprising: sending, to a database agent of the multi-agent architecture, at least a second portion of the first text data representing at least a second subset of the instructions, wherein the database agent is configured to: generate, based at least on using one or more second language models to process the second portion of the first text data, one or more structured query language (SQL) statements for one or more relational databases to execute; and generate, based at least on using the one or more second language models to process results received from the one or more relational databases responsive to executing the one or more SQL statements, third text data representing an explanation of the results, wherein the generating of the output data representative of the multimodal response to the query is further based at least on the primary agent using the one or more language models to process the third text data.

C. The method of any one of paragraphs A-B, further comprising: sending, to an analytics agent of the multi-agent architecture, at least a second portion of the first text data representing at least a second subset of the instructions, wherein the analytics agent is configured to: generate, based at least on using one or more second language models to process the second portion of the first text data, one or more application programming interface (API) calls; execute the one or more API calls to obtain analytics information corresponding to the one or more segments of the one or more videos; and generate, based at least on using the one or more second language models to process the analytics information, third text data representing an explanation of the analytics information; wherein the generating of the output data representative of the multimodal response to the query is further based at least on the primary agent using the one or more language models to process the third text data.

D. The method of any one of paragraphs A-C, wherein the instructions are indicative of, at least, one or more specialized agents of the multi-agent architecture to invoke to obtain the information, the one or more specialized agents including at least the VST agent and the VLM agent.

E. The method of any one of paragraphs A-D, wherein the VST agent, based at least on receiving the portion of the first text data from the primary agent, is configured to: generate, based at least on using one or more second language models to process the portion of the first text data, one or more application programming interface (API) calls for obtaining the one or more segments of the one or more videos; execute the one or more API calls to obtain the one or more segments of the one or more videos from a storage location; and send the one or more segments of the one or more videos to at least one of the primary agent or the VLM agent.

F. The method of any one of paragraphs A-E, further comprising: receiving, at the primary agent, a configuration file associated with the multi-agent architecture of the video management system, the configuration file indicating at least: one or more tools associated with each agent of the multi-agent architecture; one or more sample queries for each agent; and a network endpoint for each agent; and updating the one or more language models using the configuration file, wherein the generating of the first text data is based at least on the updating.

G. A system comprising: one or more processors to: obtain, from a computing device communicatively coupled with a video management system, input data representing a query; generate, based at least on using one or more first language models to process the input data, first text data representing one or more instructions; send one or more portions of the first text data to one or more agents of a plurality of agents associated with the video management system, wherein the one or more agents are configured to use one or more second language models to process the one or more portions of the first text data, wherein the one or more second language models are updated to call one or more tools to obtain information for responding to the query; generate, based at least on using the one or more first language models to process at least second text data corresponding to the information, output data representative of a response to the query; and send the output data to the computing device.

H. The system of paragraph G, wherein the one or more agents include at least a database agent that is configured to: generate, based at least on using the one or more second language models to process the one or more portions of the first text data, one or more structured query language (SQL) statements for one or more relational databases to execute; and generate, based at least on using the one or more second language models to process results received from the one or more relational databases responsive to executing the one or more SQL statements, the second text data, the second text data representing an explanation of the results.

I. The system of any one of paragraphs G-H, wherein the one or more agents include at least a video storage toolkit (VST) agent that is configured to: generate, based at least on using the one or more second language models to process the one or more portions of the first text data, one or more application programming interface (API) calls for obtaining one or more segments of one or more videos; and execute the one or more API calls to obtain the one or more segments of the one or more videos from a storage location.

J. The system of any one of paragraphs G-I, wherein the one or more agents include at least a video analytics agent that is configured to: generate, based at least on using the one or more second language models to process the one or more portions of the first text data, one or more application programming interface (API) calls; execute the one or more API calls to obtain analytics information corresponding to one or more segments of one or more videos managed by the video management system; and generate, based at least on using the one or more second language models to process the analytics information, the second text data, the second text data representing a description of the analytics information.

K. The system of any one of paragraphs G-J, wherein the information includes one or more segments of one or more videos, the one or more processors further to: send the one or more segments of the one or more videos to a vision language model (VLM) agent, the VLM agent configured to: process the one or more segments of the one or more videos using one or more VLMs; and generate the second text data based at least on the processing, wherein the second text data represents a description of content depicted in the one or more segments of the one or more videos.

L. The system of any one of paragraphs G-K, wherein the one or more agents include at least one or more first agents and one or more second agents, the one or more first agents including one or more first tools and the one or more second agents including one or more second tools that are different from the one or more first tools.

M. The system of any one of paragraphs G-L, wherein the plurality of agents include at least: one or more database agents; one or more video storage toolkit agents; one or more video analytics agents; and one or more vision language model agents.

N. The system of any one of paragraphs G-M, the one or more processors further to: receive, from the one or more agents, an indication that the one or more agents are incapable of obtaining the information; based at least on the indication, send the one or more portions of the first text data to one or more second agents of the plurality of agents; and receive, from the one or more second agents and based at least on the sending the one or more portions of the first text data, the second text data corresponding to the information.

O. The system of any one of paragraphs G-N, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

P. One or more processors comprising: processing circuitry to generate a response to a query using at least information obtained from a plurality of language model-based agents associated with a video management system, the plurality of language model-based agents including at least: a video storage toolkit (VST) agent that uses one or more first language models to convert first text data representing a request for at least a portion of a video into at least one of one or more first application programming interface (API) calls or one or more structured query language (SQL) statements to be used for obtaining the at least the portion of the video as a first portion of the information; a video analytics agent that uses one or more second language models to convert second text data representing a request for analytics information corresponding to the at least the portion of the video into one or more second API calls to be executed to obtain the analytics information as a second portion of the information; and a vision language model (VLM) agent that uses one or more VLMs to process the at least the portion of the video to generate third text data representing a description of content depicted in the at least the portion of the video as a third portion of the information.

Q. The one or more processors of paragraph P, the processing circuitry further to: receive the query from a computing device executing an instance of a user interface associated with the video management system; and send, to the computing device, output data representing the response, wherein the output data causes the computing device to present at least a portion of the response via the instance of the user interface.

R. The one or more processors of any one of paragraphs P-Q, the processing circuitry further to generate, based at least on processing the query using one or more third language models, at least the first text data and the second text data.

S. The one or more processors of any one of paragraphs P-R, wherein the plurality of language model-based agents further includes a database agent that is to process the query using one or more third language models and, based at least on the processing, generate one or more second SQL statements to be sent to one or more relational databases.

T. The one or more processors of any one of paragraphs P-S, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

U. A method comprising: generating, based at least on a primary agent of a multi-agent system using one or more language models to process input data representing a request for information, text data representing instructions associated with a plan for obtaining the information from a plurality of specialized agents; sending, based at least on the plan, one or more first portions of the text data to one or more first specialized agents of the plurality of specialized agents to obtain one or more first portions of the information; sending, based at least on the plan, one or more second portions of the text data and the one or more first portions of the information to one or more second specialized agents of the plurality of specialized agents to obtain one or more second portions of the information; generating, based at least on the primary agent using the one or more language models to process at least the one or more first portions of the information and the one or more second portions of the information, output data representative of a response to the request that includes the information; and sending, to a computing device, the output data representative of the response.

V. The method of paragraph U, further comprising: sending, at a first time and based at least on the plan, the one or more first portions of the text data to one or more third specialized agents of the plurality of specialized agents; receiving, from the one or more third specialized agents responsive to the sending of the one or more first portions of the text data, an indication that the one or more third specialized agents are incapable of providing the one or more first portions of the information; and determining, by the primary agent and based at least on the indication, to send the one or more first portions of the text data to the one or more first specialized agents, wherein the one or more first portions of the text data are sent to the one or more first specialized agents at a second time after the first time.

W. The method of any one of paragraphs U-V, wherein the one or more first specialized agents include at least a database agent, the database agent configured to perform operations comprising: generating, based at least on using one or more second language models to process the one or more first portions of the text data, one or more structured query language (SQL) statements for one or more relational databases to execute; obtaining results associated with the one or more relational databases executing the one or more SQL statements; and generating, based at least on using the one or more second language models to process at least a portion of the results, one or more strings of text representative of a description of the results, wherein the one or more first portions of the information include the one or more strings of text.

X. The method of any one of paragraphs U-W, wherein, based at least on receiving the one or more first portions of the text data from the primary agent, the one or more first specialized agents are configured to perform operations comprising: generating, based at least on using one or more second language models to process the one or more first portions of the text data, text representative of code for making one or more application programming interface (API) calls; obtaining, based at least on using the code to execute the one or more API calls, the one or more first portions of the information; and sending the one or more first portions of the information to the primary agent.

Y. The method of any one of paragraphs U-X, further comprising: receiving at the primary agent, a configuration file associated with the multi-agent system, the configuration file indicating at least: one or more respective capabilities of each one of the plurality of specialized agents; one or more respective sample queries that each one of the plurality of specialized agents is configured to solve; and respective network endpoints for each one of the plurality of specialized agents; and updating at least the one or more language models associated with the primary agent using the configuration file, wherein the generating of the text data representing the instructions using the one or more language models is based at least on the updating.

Z. The method of any one of paragraphs U-Y, wherein at least one of the one or more first specialized agents or the one or more second specialized agents are configured to cause one or more autonomous or semi-autonomous machines to perform one or more control operations.

AA. The method of any one of paragraphs U-Z, wherein the response is a multimodal response including a combination of two or more of: text data; audio data; video data; or image data.

BB. A system comprising: one or more processors to: obtain, from a computing device, input data representing a query; send at least one or more portions of the input data to one or more agents of a plurality of agents of a multi-agent system, the one or more agents including one or more first language models and one or more tools for determining information associated with responding to the query; receive, based at least on the sending, at least one or more portions of the information from the one or more agents; generate, based at least on using one or more second language models to process at least the one or more portions of the information, output data representative of a response to the query; and send, to the computing device, the output data representative of the response.

CC. The system of paragraph BB, wherein the one or more agents include at least one or more first agents and one or more second agents, the one or more first agents including one or more first tools and the one or more second agents including one or more second tools that are different from the one or more first tools.

DD. The system of any one of paragraphs BB-CC, wherein the plurality of agents include at least: one or more database agents; one or more video storage toolkit agents; one or more analytics agents; one or more documentation agents; one or more machine control agents; and one or more vision language model agents.

EE. The system of any one of paragraphs BB-DD, wherein the one or more agents include at least a control agent and the one or more tools of the control agent include at least a tool to cause one or more machines to perform one or more operations based at least on receiving the one or more portions of the input data.

FF. The system of any one of paragraphs BB-EE, the one or more processors further to: generate, based at least on using the one or more second language models to process the input data, one or more text strings representative of one or more instructions for sending to the one or more agents to obtain the information associated with responding to the query, wherein the sending of the one or more portions of the input data to the one or more agents comprises sending the one or more text strings to the one or more agents.

GG. The system of any one of paragraphs BB-FF, the one or more processors further to: send the one or more portions of the input data to one or more second agents of the plurality of agents; and receive, from the one or more second agents, one or more indications that the one or more second agents are incapable of providing the one or more portions of the information, wherein the sending of the one or more portions of the input data to the one or more agents is based at least on the reception of the one or more indications.

HH. The system of any one of paragraphs BB-GG, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

II. One or more processors comprising: processing circuitry to: generate, based at least on using one or more first language models to process first text data representing a first query, second text data representing one or more second queries; receive, from one or more agents of a multi-agent system, one or more text strings representing one or more responses to the one or more second queries, the one or more text strings generated by the one or more agents based at least on using one or more second language models to process information determined using one or more tools of the one or more agents; generate, based at least on using the one or more first language models to process at least the one or more text strings, output data representative of a response to the first query; and cause to present content based on the output data.

JJ. The one or more processors of paragraph II, wherein the one or more agents include at least a first agent and a second agent, the first agent including one or more first tools and the second agent including one or more second tools that are different from the one or more first tools.

KK. The one or more processors of any one of paragraphs II-JJ, wherein the multi-agent system includes at least: one or more database agents; one or more video storage toolkit agents; one or more analytics agents; one or more documentation agents; one or more machine control agents; and one or more vision language model agents.

LL. The one or more processors of any one of paragraphs II-KK, wherein the one or more agents include at least one of: the one or more database agents; the one or more video storage toolkit agents; the one or more analytics agents; the one or more documentation agents; the one or more machine control agents; or the one or more vision language model agents.

MM. The one or more processors of any one of paragraphs II-LL, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more multi-model language models; a system implementing one or more large language models (LLMs); a system implementing one or more small language models (SLMs); a system implementing one or more vision language models (VLMs); a system for generating synthetic data; a system for generating synthetic data using AI; a system incorporating one or more virtual machines (VMs); a system implemented at least partially in a data center; or a system implemented at least partially using cloud computing resources.

What is claimed is:

1. A method comprising:
generating, based at least on a primary agent of a multi-agent architecture associated with a video management system using one or more language models to process input data representing a query, first text data representing instructions for obtaining information for responding to the query;
sending, to a video storage toolkit (VST) agent of the multi-agent architecture, at least a portion of the first text data representing at least a subset of the instructions, the subset of the instructions including one or more requests for the VST agent to obtain one or more segments of one or more videos;
sending, to a vision language model (VLM) agent of the multi-agent architecture, the one or more segments of the one or more videos obtained using the VST agent;
receiving, from the VLM agent and based at least on the VLM agent using one or more VLMs to process the one or more segments of the one or more videos, second text data representing one or more descriptions of content depicted in the one or more segments of the one or more videos;
generating, based at least on the primary agent using the one or more language models to process at least the first text data and the second text data, output data representative of a multimodal response to the query; and
sending, using the primary agent and to a computing device, the output data.

2. The method of claim 1, further comprising:
sending, to a database agent of the multi-agent architecture, at least a second portion of the first text data representing at least a second subset of the instructions, wherein the database agent is configured to:
generate, based at least on using one or more second language models to process the second portion of the first text data, one or more structured query language (SQL) statements for one or more relational databases to execute; and
generate, based at least on using the one or more second language models to process results received from the one or more relational databases responsive to executing the one or more SQL statements, third text data representing an explanation of the results,
wherein the generating of the output data representative of the multimodal response to the query is further based at least on the primary agent using the one or more language models to process the third text data.

3. The method of claim 1, further comprising:
sending, to an analytics agent of the multi-agent architecture, at least a second portion of the first text data representing at least a second subset of the instructions, wherein the analytics agent is configured to:
generate, based at least on using one or more second language models to process the second portion of the first text data, one or more application programming interface (API) calls;
execute the one or more API calls to obtain analytics information corresponding to the one or more segments of the one or more videos; and
generate, based at least on using the one or more second language models to process the analytics information, third text data representing an explanation of the analytics information;
wherein the generating of the output data representative of the multimodal response to the query is further based at least on the primary agent using the one or more language models to process the third text data.

4. The method of claim 1, wherein the instructions are indicative of, at least, one or more specialized agents of the multi-agent architecture to invoke to obtain the information, the one or more specialized agents including at least the VST agent and the VLM agent.

5. The method of claim 1, wherein the VST agent, based at least on receiving the portion of the first text data from the primary agent, is configured to:
generate, based at least on using one or more second language models to process the portion of the first text data, one or more application programming interface (API) calls for obtaining the one or more segments of the one or more videos;
execute the one or more API calls to obtain the one or more segments of the one or more videos from a storage location; and
send the one or more segments of the one or more videos to at least one of the primary agent or the VLM agent.

6. The method of claim 1, further comprising:
receiving, at the primary agent, a configuration file associated with the multi-agent architecture of the video management system, the configuration file indicating at least:
one or more tools associated with each agent of the multi-agent architecture;
one or more sample queries for each agent; and
a network endpoint for each agent; and
updating the one or more language models using the configuration file,
wherein the generating of the first text data is based at least on the updating.

7. A system comprising:
one or more processors to:
obtain, from a computing device communicatively coupled with a video management system, input data representing a query;
generate, based at least on using one or more first language models to process the input data, first text data representing one or more instructions;
send one or more portions of the first text data to one or more agents of a plurality of agents associated with the video management system, wherein the one or more agents are configured to use one or more second language models to process the one or more portions of the first text data, wherein the one or more second language models are updated to call one or more tools to obtain information for responding to the query;
generate, based at least on using the one or more first language models to process at least second text data corresponding to the information, output data representative of a response to the query; and
send the output data to the computing device.

8. The system of claim 7, wherein the one or more agents include at least a database agent that is configured to:
generate, based at least on using the one or more second language models to process the one or more portions of the first text data, one or more structured query language (SQL) statements for one or more relational databases to execute; and
generate, based at least on using the one or more second language models to process results received from the one or more relational databases responsive to executing the one or more SQL statements, the second text data, the second text data representing an explanation of the results.

9. The system of claim 7, wherein the one or more agents include at least a video storage toolkit (VST) agent that is configured to:
generate, based at least on using the one or more second language models to process the one or more portions of the first text data, one or more application programming interface (API) calls for obtaining one or more segments of one or more videos; and
execute the one or more API calls to obtain the one or more segments of the one or more videos from a storage location.

10. The system of claim 7, wherein the one or more agents include at least a video analytics agent that is configured to:
generate, based at least on using the one or more second language models to process the one or more portions of the first text data, one or more application programming interface (API) calls;
execute the one or more API calls to obtain analytics information corresponding to one or more segments of one or more videos managed by the video management system; and
generate, based at least on using the one or more second language models to process the analytics information, the second text data, the second text data representing a description of the analytics information.

11. The system of claim 7, wherein the information includes one or more segments of one or more videos, the one or more processors further to:
send the one or more segments of the one or more videos to a vision language model (VLM) agent, the VLM agent configured to:
process the one or more segments of the one or more videos using one or more VLMs; and
generate the second text data based at least on the processing, wherein the second text data represents a description of content depicted in the one or more segments of the one or more videos.

12. The system of claim 7, wherein the one or more agents include at least one or more first agents and one or more second agents, the one or more first agents including one or more first tools and the one or more second agents including one or more second tools that are different from the one or more first tools.

13. The system of claim 7, wherein the plurality of agents include at least:
one or more database agents;
one or more video storage toolkit agents;
one or more video analytics agents; and
one or more vision language model agents.

14. The system of claim 7, the one or more processors further to:
receive, from the one or more agents, an indication that the one or more agents are incapable of obtaining the information;
based at least on the indication, send the one or more portions of the first text data to one or more second agents of the plurality of agents; and
receive, from the one or more second agents and based at least on the sending the one or more portions of the first text data, the second text data corresponding to the information.

15. The system of claim 8, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

16. One or more processors comprising:
processing circuitry to generate a response to a query using at least information obtained from a plurality of language model-based agents associated with a video management system, the plurality of language model-based agents including at least:
a video storage toolkit (VST) agent that uses one or more first language models to convert first text data representing a request for at least a portion of a video into at least one of one or more first application programming interface (API) calls or one or more structured query language (SQL) statements to be used for obtaining the at least the portion of the video as a first portion of the information;
a video analytics agent that uses one or more second language models to convert second text data representing a request for analytics information corresponding to the at least the portion of the video into one or more second API calls to be executed to obtain the analytics information as a second portion of the information; and
a vision language model (VLM) agent that uses one or more VLMs to process the at least the portion of the video to generate third text data representing a description of content depicted in the at least the portion of the video as a third portion of the information.

17. The one or more processors of claim 16, the processing circuitry further to:
receive the query from a computing device executing an instance of a user interface associated with the video management system; and
send, to the computing device, output data representing the response, wherein the output data causes the computing device to present at least a portion of the response via the instance of the user interface.

18. The one or more processors of claim 16, the processing circuitry further to generate, based at least on processing the query using one or more third language models, at least the first text data and the second text data.

19. The one or more processors of claim 16, wherein the plurality of language model-based agents further includes a database agent that is to process the query using one or more third language models and, based at least on the processing, generate one or more second SQL statements to be sent to one or more relational databases.

20. The one or more processors of claim 16, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
